(19) United States
(12) Patent Application Publication
(10) Pub. No.: US 2003/0073650 A1
(43) Pub. Date: Apr. 17, 2003

(54) Method and apparatus for inactivation of biological contaminants using photosensitizers

(76) Inventors: Heather Reddy, Denver, CO (US); Raymond P. Goodrich, Lakewood, CO (US)

Correspondence Address: GREENLEE WINNER AND SULLIVAN P C, 5370 MANHATTAN CIRCLE, SUITE 201, BOULDER, CO, 80303, US

(21) Appl. No.: 10/159,781

(22) Filed: May 30, 2002

Related U.S. Application Data
(63) Continuation-in-part of application No. 09/586,147, filed on Jun. 2, 2000.
Application No. 09/586,147 is a continuation-in-part of application No. 09/357,188, filed on Jul. 20, 1999, now Pat. No. 6,277,337.
Application No. 09/357,188 is a continuation-in-part of application No. 09/119,666, filed on Jul. 21, 1998, now Pat. No. 6,258,577.
(60) Provisional application No. 60/294,866, filed on May 30, 2001.
(60) Provisional application No. 60/373,465, filed on Apr. 17, 2002.
(60) Provisional application No. 60/353,321, filed on Feb. 1, 2002.

(51) Int. Cl. A01N 1/02

(52) U.S. Cl. 514/43; 435/2

(57) ABSTRACT

Methods and apparatuses are provided for inactivation of microorganisms in fluids or on surfaces. Preferably the fluids contain blood or blood products and comprise biologically active proteins. Preferred methods for inactivation of microorganisms include the steps of adding an effective, non-toxic amount of an endogenous photosensitizer and a quencher to a fluid and exposing the fluid to photoradiation sufficient to active the endogenous photosensitizer whereby microorganisms are inactivated. The quencher reduces side reactions generated by a photosensitizer and light that can damage desired biological components.

### CROSS-REFERENCE TO RELATED APPLICATIONS

This application is a continuation-in-part of co-pending U.S. application Ser. No. 09/586,147, filed Jun. 2, 2000 which is a continuation-in-part of U.S. application Ser. No. 09/119,666 filed Jul. 21, 1998, which is a continuation-in-part of U.S. application Ser. No. 09/357,188, filed Jul. 20, 1999. This application claims priority to U.S. provisional application 60/294,866, filed May 30, 2001; U.S. provisional application 60/373,465, filed Apr. 17, 2002 and U.S. provisional application 60/353,321, filed Feb. 1, 2002. All applications listed above are hereby incorporated herein in their entirety to the extent not inconsistent with the disclosure herewith.

### BACKGROUND

Contamination of blood supplies with infectious microorganisms such as HIV, hepatitis and other viruses and bacteria presents a serious health hazard for those who must receive transfusions of whole blood or administration of various blood components such as platelets, red cells, blood plasma, Factor VIII, plasminogen, fibronectin, anti-thrombin III, cryoprecipitate, human plasma protein fraction, albumin, immune serum globulin, prothrombin complex plasma growth hormones, and other components isolated from blood. Blood screening procedures currently available may miss contaminants. Thus, there is a need for sterilization procedures that effectively neutralize all infectious viruses and other microorganisms but do not damage cellular blood components, do not degrade desired biological activities of proteins, and preferably do not need to be removed prior to administration of the blood product to the patient.

The use of photosensitizers, compounds which absorb light of a defined wavelength and transfer the absorbed energy to an energy acceptor, has been proposed as a solution to the contamination of blood and blood components. Various photosensitizers have been proposed for use as blood additives for pathogen inactivation of blood or blood components. A review of some photosensitizers including psoralens, and some of the issues of importance in choosing photosensitizers for decontamination of blood products is provided in Goodrich, R. P., et al. (1997), “The Design and Development of Selective, Photoactivated Drugs for Sterilization of Blood Products,” Drugs of the Future 22:159-171.

Some photosensitizers that have been proposed for use for blood component photoirradiation have undesirable properties. For example, European Patent Application 196,515 published Oct. 8, 1986, suggests the use of non-endogenous photosensitizers such as porphyrins, psoralens, acridine, toluidines, flavine (acriflavine hydrochloride), phenothiazine derivatives, and dyes such as neutral red and methylene blue, as blood additives. Another molecule, chlorpromazine, has been used as a photosensitizer; however its usefulness is limited by the fact that it should be removed from any fluid administered to a patient after the decontamination procedure because it has a sedative effect. Protoporphyrin, which occurs naturally within the body, can be metabolized to form a photosensitizer; however, its usefulness is limited in that it degrades the desired biological activities of proteins.

Pathogen kill using riboflavin and related photosensitizer compounds occurs upon photoinactivation via oxidative damage, including singlet oxygen damage, or via binding of the photosensitizer to nucleic acids of the pathogen, thereby disrupting the ability of the pathogen to function and reproduce, or both. Side reactions of photolysis, may cause damage to blood products and compromise their suitability for transfusions.

A few patents discuss the use of additives to quench side reactions. U.S. Pat. No. 6,077,659 (Jun. 20, 2000) to Ben-Hur et al. discusses the use of vitamin E and a phthalocyanine porphyrin-like photosensitizer to inactivate viruses. U.S. Pat. No. 6,270,952 (Aug. 7, 2001) to Cook et al. discusses the use of glutathione with a quinacrine compound to inactivate pathogens.

There is a need in the art for methods to reduce collateral damage to blood components treated with a photosensitizer and light. This invention prevents or reduces collateral damage to pathogen inactivated blood and blood components.

All publications referred to herein are hereby incorporated by reference to the extent not inconsistent herewith.

### SUMMARY

The invention is directed to a method for quenching side reactions generated by a photosensitizer and light. The side reactions may cause unwanted damage to desired biological components.

The invention is more specifically directed to a method of inactivating pathogens in a blood component which may contain pathogens comprising: adding a photosensitizer and a quencher to the blood component and illuminating the blood component, photosensitizer and quencher for a time sufficient to inactivate any pathogens contained therein. The quencher may also be added after illumination of the blood component and photosensitizer. The quencher may also be added to a storage solution used to store the blood or blood component after irradiation. In another embodiment, a dry composition is provided which is adapted to be mixed with a solvent, comprising a quencher and a photosensitizer. The invention is further directed towards an additive solution comprising at least one quencher for quenching side reactions generated in a solution containing blood or blood component and a photosensitizer by application of light energy. This invention also provides a fluid comprising biologically active protein, blood or blood constituents and inactivated microorganisms, endogenous photosensitizer or photoproduct thereof, and one or more quenchers.

Also provided is a method for inactivation of microorganisms in a fluid, said fluid also containing a component selected from the group consisting of biologically active protein, blood, and blood constituents, said method comprising: adding an effective amount of an endogenous photosensitizer to said fluid; exposing the fluid to photoradiation sufficient to activate the photosensitizer; allowing the activated endogenous photosensitizer to inactivate microorganisms in said fluid, this invention provides an improvement comprising: adding to said fluid an effective amount of a quencher to offset damage by said photosensitizer and/or the photoradiation to cell membranes and proteins without substantially reducing the effectiveness of said photosensitizer to inactivate said microorganisms.

In one specific preferred embodiment, this invention is directed towards reducing damage to cells from side reactions that occur when a composition containing red blood cells and riboflavin is irradiated with visible light without interfering with the inactivation of pathogens by riboflavin.

As used herein, the terms “blocking agent” or “quenching agent” or “quencher” refer to compounds that reduce damage to biological components caused by the compounds and/or conditions used for pathogen inactivation. Some side reactions which may damage cell membrances of blood and blood components include formation of reactive oxygen species from the application of visible light to solutions containing photosensitizers. These side reactions are known to one of ordinary skill in the art. The specific use of a quencher can selectively protect cell membranes from oxidation damage while permitting oxygen-based chemistry to proceed in solution where virus and other pathogenic agents primarily reside. In this way, the positive effects of oxidation chemistry can be utilized for pathogen kill while the negative side-effects of cell and protein damage are eliminated.

One class of quenching agents are thiol containing compounds including glutathione, n-acetyl-cysteine, and cysteine. Another class of quenching agents are amino acids such as tryptophan, tyrosine, histidine, adenine and methionine. Another class of quenching agents are antioxidants, including Vitamin E, TPGS, trolox and Vitamin C and their derivatives.

Different quenchers may act with different mechanisms. Antioxidants as well as thiol-containing compounds may help prevent denaturation of proteins in blood by side reactions during the irradiation process. Amino acids may act as false targets for the side reactions which occur during the irradiation process, thus protecting the blood proteins.

Quenchers may also be added to the fluid to make the process more efficient and selective. Such quenchers include antioxidants or other agents to prevent damage to desired fluid components or to improve the rate of inactivation of microorganisms and are exemplified by adenine, histidine, cysteine, tyrosine, tryptophan, ascorbate, N-acetyl-L-cysteine, propyl gallate, glutathione, mercaptopropionylglycine, dithiothreotol, nicotinamide, BHT, BHA, lysine, serine, methionine, glucose, mannitol, trolox, glycerol, vitamin E and mixtures thereof.

Quenchers can be used in any effective amount. All specific concentration amounts and intermediate ranges are included in the disclosure. A preferred range is from 0.05 to about 100 millimolar, more preferably from 0.1 to 20 millimolar. When used as a quencher, thiol containing compounds are preferably added in an amount of between 0.5-50 mM, and most preferably between about 0.1-20 mM. When used as a quencher, Vitamin E is preferably added in an amount of between about 0.1 and about 200 IU/ml, and more preferably about 0.1 to about 1 IU/ml. When used as a quencher, Vitamin C is preferably added in an amount of between about 0.1 to 100 millimolar, preferably about 5 to about 15 millimolar, and more preferably about 10 millimolar. The preferred concentrations of other quenchers may be determined by one of ordinary skill in the art without undue experimentation by analysis of the desired level of microorganism inactivation, the desired photosensitizer and other parameters, as taught herein and known to one of ordinary skill in the art.

As described herein and known to one of ordinary skill in the art, quenching agents can be used in a variety of different ways in the methods of the invention. Quenchers may be added to the blood component at any stage of the process. For example, the quenchers may be added before adding photosensitizer and exposure to light, or may be added after exposure of the blood component to light. Quenching agents can be added to a solution used to store blood or blood components. Quenching agents can be added to blood or blood components along with the desired photosensitizer. Compositions containing quenching agents can be used in a dry form or a liquid form. Some preferred uses are given below. The quenchers of the invention may be used with platelet and red blood cell additive solutions and other blood component additive solutions as known in the art.

It is preferred that the quencher react with the pathogen inactivating compound to quench side reactions without interfering with pathogen inactivation by the pathogen inactivating compound. This may occur, for example, by the use of a quencher which substantially does not traverse pathogen membranes, and therefore quenches side reactions outside the pathogen membranes. In another embodiment, the quencher may react kinetically so slowly with the pathogen inactivating compound, or reactive intermediates formed therefrom, that it substantially does not interfere with pathogen inactivation. It is also preferred that the quencher does not negatively interact with the blood or blood components to be pathogen inactivated. An effective amount of quencher is an amount that reduces undesired side reactions generated by illumination of a photosensitizer without causing the effectiveness of the photosensitizer to inactivate microorganisms to fall below a desired level.

In particular, the method of this invention improves the quality of blood or blood components treated with a pathogen-inactivation procedure, permitting more stringent pathogen inactivation processes to be utilized without compromising the integrity of the therapeutic components. An amount of photosensitizer higher than that used in previously-known methods for inactivation of microorganisms may be used when a quencher is added to offset damage to desired components of the fluid from photoirradiation.

Decontamination methods of this invention using quenchers, endogenous photosensitizers and endogenously-based photosensitizer derivatives do not substantially destroy the biological activity of fluid components other than microorganisms. As much biological activity of these components as possible is retained, although in certain instances, when the methods are optimized, some loss of biological activity, e.g., denaturization of protein components, must be balanced against effective decontamination of the fluid. So long as fluid components retain sufficient biological activity to be useful for their intended or natural purposes, their biological activities are not considered to be “substantially destroyed.”

The quenchers, endogenous photosensitizers and endogenously-based derivative photosensitizers disclosed herein can be used in pre-existing blood component decontamination systems as well as in the decontamination system disclosed herein. For example, the endogenous photosensitizers and endogenously-based derivative photosensitizers of this invention can be used in the decontamination systems described in U.S. Pat. Nos. 5,290,221, 5,536,238, 5,290,221 and 5,536,238.

### BRIEF DESCRIPTION OF THE FIGURES

FIG. 1 depicts inactivation of bacteria as a function of platelet preparation and energy of irradiation, using 90% platelets in plasma and 10% platelet additive solution (90:10) and 30% platelets with 70% additive solution (30:70).

FIG. 2 shows the effect on inactivation of virus, bacteriophage and bacteria of adding antioxidants to platelet concentrate.

FIG. 3 shows the inactivation curve for Herpes Simplex type II virus as a function of concentration of photosensitizer at an energy of irradiation of 20 J/cm² using half ultraviolet and half visible light.

FIG. 4 shows inactivation of S. epidermidis at varying concentrations of photosensitizer and energies of irradiation.

FIG. 5 shows inactivation of Φ X174 at varying concentrations of photosensitizer and energies of irradiation.

FIG. 6 shows inactivation of S. aureus and Φ X174 at varying energies of irradiation using a 50:50 mixture of ultraviolet and visible light.

FIG. 7 shows inactivation of S. epidermidis and HSV-II at varying energies of irradiation using a 50:50 mixture of ultraviolet and visible light.

FIG. 8 shows inactivation of HSV2 virus in blood bags agitated and irradiated at varying energy levels.

FIG. 9 compares inactivation results for vaccinia virus in various fluids using ultraviolet light alone or 50:50 visible and ultraviolet light.

FIG. 10 compares inactivation results with and without sensitizer of vaccinia virus at varying irradiation times.

FIG. 11 compares inactivation of extracellular HIV-1 at 5 and 50 μM of photosensitizer and varying irradiation energies.

FIG. 12 compares inactivation of intracellular HIV-1 at 5 and 50 μM of photosensitizer and varying irradiation energies.

FIG. 13 compares inactivation of intracellular HIV-1 at 5 and 50 μM of photosensitizer and varying irradiation energies, using p24 antigen levels.

FIG. 14 shows inactivation of HSV-II at varying irradiation levels using platelet concentrate and platelet concentrate in media containing platelet additive solution with ascorbate.

FIG. 15 shows an embodiment of this invention using a blood bag to contain the fluid being treated and photosensitizer and a shaker table to agitate the fluid while exposing to photoradiation from a light source.

FIG. 16 shows an embodiment of this invention using blood bags which are prepackaged to contain the photosensitizer necessary for inactivation of contaminants in the blood or other bodily fluid.

FIG. 17 shows an embodiment of this invention using blood bags as in FIG. 16 with a container in the tubing line between the bags.

FIG. 18 shows BVDV kill in red blood cells using different treatment conditions over time.

FIG. 19 compares the log reduction of BVDV in washed red blood cells as compared to un-washed red blood cells with and without quencher.

FIG. 20 shows the inactivation kinetics (log virus titre) of BVDV virus in the presence and absence of Vitamin E in platelets.

FIG. 21 shows the level of inactivation observed between samples with and without Vitamin E in platelets.

FIG. 22 shows the survival of radiolabelled primate platelets under varying treatment conditions (with and without antioxidants and untreated controls).

### DETAILED DESCRIPTION

A “photosensitizer” is defined as any compound which absorbs radiation of one or more defined wavelengths and subsequently utilizes the absorbed energy to carry out a chemical process. Photosensitizers used in this invention may include compounds which preferentially adsorb to nucleic acids, thus focusing their photodynamic effect upon microorganisms and viruses with little or no effect upon accompanying cells or proteins. Other photosensitizers are also useful in this invention, such as those using type I (free-radical) and/or type II (singlet oxygen) dependent mechanisms.

Most preferred are endogenous photosensitizers. The term “endogenous” means naturally found in a human or mammalian body, either as a result of synthesis by the body or because of ingestion as an essential foodstuff (e.g. vitamins) or formation of metabolites and/or byproducts in vivo. Examples of such endogenous photosensitizers are alloxazines such as 7,8-dimethyl-10-ribityl isoalloxazine (riboflavin), 7,8,10-trimethylisoalloxazine (lumiflavin), 7,8-dimethylalloxazine (lumichrome), isoalloxazine-adenine dinucleotide (flavine adenine dinucleotide [FAD]), alloxazine mononucleotide (also known as Ravine mononucleotide [FMN] and riboflavine-5-phosphate), vitamin Ks, vitamin L, their metabolites and precursors, and napththoquinones, naphthalenes, naphthols and their derivatives having planar molecular conformations. The term “alloxazine” includes isoalloxazines. Endogenously-based derivative photosensitizers include synthetically derived analogs and homologs of endogenous photosensitizers which may have or lack lower (1-5) alkyl or halogen substituents of the photosensitizers from which they are derived, and which preserve the function and substantial non-toxicity thereof. When endogenous photosensitizers are used, particularly when such photosensitizers are not inherently toxic or do not yield toxic photoproducts after photoradiation, no removal or purification step is required after decontamination, and treated product can be directly returned to a patient's body or administered to a patient in need of its therapeutic effect.

Preferred endogenous photosensitizers are:

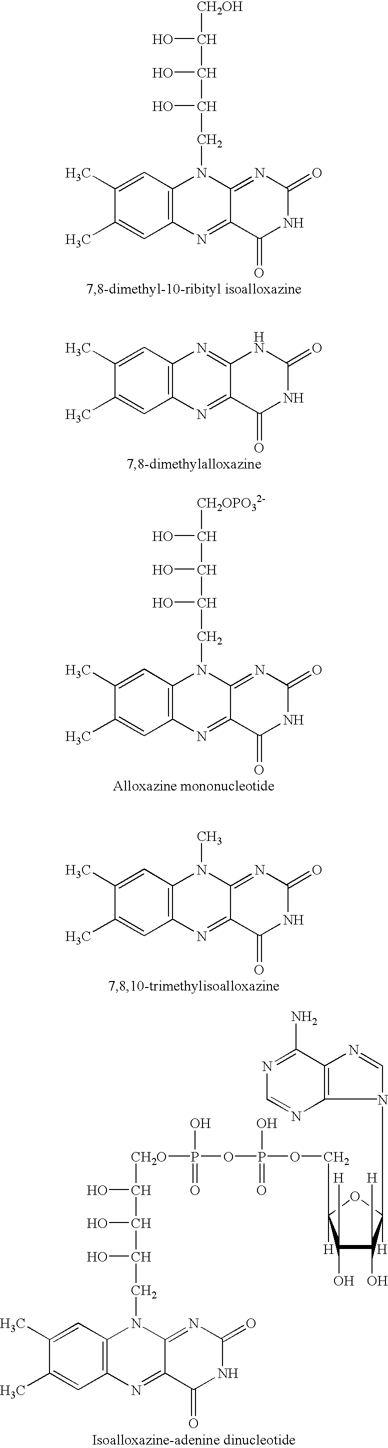

Pathogen inactivation requires mixing the photosensitizer with the material to be decontaminated. Mixing may be done by simply adding the photosensitizer or a solution containing the photosensitizer to the fluid to be decontaminated. In one system, the material to be decontaminated to which the photosensitizer has been added is flowed past a photoradiation source, and the flow of the material generally provides sufficient turbulence to distribute the photosensitizer throughout the fluid to be decontaminated. In another system, the fluid and photosensitizer are placed in a photopermeable container and irradiated in batch mode, preferably while agitating the container to fully distribute the photosensitizer and expose all the fluid to the radiation. As described herein, quenchers can be added to the system at any desired stage in the process including mixing with the photosensitizer prior to irradiation.

The amount of photosensitizer to be mixed with the fluid will be an amount sufficient to adequately inactivate microorganisms therein, but less than a toxic (to humans or other mammals) or insoluble amount. As taught in published Patent Application WO 00/04930 and incorporated herein by reference in its entirety to the amount not inconsistent herewith, optimal concentrations for desired photosensitizers may be readily determined by those skilled in the art without undue experimentation. Preferably the photosensitizer is used in a concentration of at least about 1 μM up to the solubility of the photosensitizer in the fluid, and preferably about 10 μM. For 7,8-dimethyl-10-ribityl isoalloxazine a concentration range between about 1 μM and about 500 μM is preferred, preferably about 50 μM for platelets and plasma and preferably about 450 μM for red blood cells.

The fluid to be treated is exposed to photoradiation of the appropriate wavelength to activate the photosensitizer, using an amount of photoradiation sufficient to activate the photosensitizer as described above, but less than that which would cause non-specific damage to the biological components or substantially interfere with biological activity of other proteins present in the fluid. The wavelength used will depend on the photosensitizer selected, as is known in the art or readily determinable without undue experimentation following the teachings hereof.

U.S. Pat. No. 6,258,577 and continuation in part 6,277,337, hereby incorporated by reference to the extent not inconsistent with the disclosure herein, describes methods and apparatus for pathogen inactivation of biological contaminants using endogenous photosensitizers, including 7,8-dimethyl-10-ribityl isoalloxazine (riboflavin). U.S. Pat. No. 6,268,120, hereby incorporated by reference to the extent not inconsistent with the disclosure herein also describes pathogen inactivation of biological contaminants using isoalloxazine derivatives. Inactivation methods using endogenous photosensitizers are also described in U.S. patent application Ser. Nos. 09/596,429 filed Jun. 1, 2000 and 09/777,727 filed Feb. 5, 2001 all of which are hereby incorporated by reference to the extent not inconsistent with the disclosure herein. Other methods for photoinactivation of microorganisms are known to the art. The methods of this invention involving the use of quenchers are useful with all such inactivation methods.

As used herein, the term “inactivation of a microorganism” means totally or partially preventing the microorganism from replicating, either by killing the microorganism or otherwise interfering with its ability to reproduce.

Microorganisms include viruses (both extracellular and intracellular), bacteria, bacteriophages, fungi, blood-transmitted parasites, and protozoa. Exemplary viruses include acquired immunodeficiency (HIV) virus, hepatitis A, B and C viruses, sinbis virus, cytomegalovirus, vesicular stomatitis virus, herpes simplex viruses, e.g. types I and II, human T-lymphotropic retroviruses, HTLV-III, lymphadenopathy virus LAV/IDAV, parvovirus, transfusion-transmitted (TT) virus, Epstein-Barr virus, and others known to the art. Bacteriophages include Φ X174, Φ 6, λ, R17, T₄, and T₂. Exemplary bacteria include P. aeruginosa, S. aureus, S. epidermis, L. monocytogenes, E. coli, K. pneumonia and S. marcescens.

Inactivation of white blood cells may be desirable when suppression of immune or autoimmune response is desired, e.g., in processes involving transfusion of red cells, platelets or plasma when donor white blood cells may be present.

Materials which may be treated by the methods of this invention include any materials which are adequately permeable to photoradiation to provide sufficient light to achieve viral inactivation, or which can be suspended or dissolved in fluids which have such permeability to photoradiation. Examples of such materials are whole blood and aqueous compositions containing biologically active proteins derived from blood or blood constituents. Packed red cells, platelets and plasma (fresh or fresh frozen plasma) are exemplary of such blood constituents. In addition, therapeutic protein compositions containing proteins derived from blood, such as fluids containing biologically active protein useful in the treatment of medical disorders, e.g. factor VIII, Von Willebrand factor, factor IX, factor X, factor XI, Hageman factor, prothrombin, anti-thrombin III, fibronectin, plasminogen, plasma protein fraction, immune serum globulin, modified immune globulin, albumin, plasma growth hormone, somatomedin, plasminogen streptokinase complex, ceruloplasmin, transferrin, haptoglobin, antitrypsin and prekallikrein may be treated by the decontamination methods of this invention. Other fluids which could benefit from the treatment of this invention are peritoneal solutions used for peritoneal dialysis which are sometimes contaminated during connection, leading to peritoneal infections. The material to be treated is preferably a fluid that comprises blood constituents, e.g. whole blood, platelets, plasma, white blood cells, or red blood cells. The fluid may be a separated blood product. The method is especially useful for treating platelets. The use of Vitamin E as a quencher is preferred for platelet treatment. When red blood cells are treated, thiol-containing compounds such as glutathione are preferably used as quenchers.

The term “biologically active” means capable of effecting a change in a living organism or component thereof. “Biologically active” with respect to “biologically active protein” as referred to herein does not refer to proteins which are part of the microorganisms being inactivated. Similarly, “non-toxic” with respect to the photosensitizers means low or no toxicity to humans and other mammals, and does not mean non-toxic to the microorganisms being inactivated. “Substantial destruction” of biological activity means at least as much destruction as is caused by porphyrin and porphyrin derivatives, metabolites and precursors which are known to have a damaging effect on biologically active proteins and cells of humans and mammals. Similarly, “substantially non-toxic” means less toxic than porphyrin, porphyrin derivatives, metabolites and precursors that are known for blood sterilization.

The term “blood product” as used herein includes blood constituents and therapeutic protein compositions containing proteins derived from blood as defined above. Fluids containing biologically active proteins other than those derived from blood may also be treated by the methods of this invention.

A “solution useful for storing blood components” is any of a number of solutions that are known in the art to be useful for storing blood components. Examples are given herein. Any suitable container and apparatus may be used for irradiation, as known in the art. Either flow through or batch treatment may be used. In an embodiment involving batch-wise treatment, the fluid to be treated is placed in a photopermeable container which is agitated and exposed to photoradiation for a time sufficient to substantially inactivate the microorganisms. The photopermeable container is preferably a blood bag made of transparent or semitransparent plastic, and the agitating means is preferably a shaker table. The photosensitizer and quencher may be added to the container in dry form as a powder, tablet, capsule or pill or in liquid form and the container agitated to mix the photosensitizer and quencher with the fluid and to adequately expose all the fluid to the photoradiation to ensure inactivation of microorganisms.

Quencher and/or photosensitizer may be added to or flowed into the photopermeable container separately from the fluid being treated or may be added to the fluid prior to placing the fluid in the container. In one embodiment, photosensitizer and quencher are added to anticoagulant and the mixture of photosensitizer, quencher and anticoagulant are added to the fluid. The photosensitizer and quencher may be added to the photopermeable container before sterilization of such container or after sterilization. Quenchers may be added in any effective amount. A preferred range is from 0.05 to 100 millimolar, more preferably from 0.1 to 20 millimolar.

In decontamination systems of this invention, the photoradiation source may be connected to the photopermeable container for the fluid by means of a light guide such as a light channel or fiber optic tube which prevents scattering of the light between the source and the container for the fluid, and more importantly, prevents substantial heating of the fluid within the container. Direct exposure to the light source may raise temperatures as much as 10 to 15° C., especially when the amount of fluid exposed to the light is small, which can cause denaturization of blood components. Use of the light guide keeps any heating to less than about 2° C. The method may also include the use of temperature sensors and cooling mechanisms where necessary to keep the temperature below temperatures at which desired proteins in the fluid are damaged. Preferably, the temperature is kept between about 0° C. and about 45° C., more preferably between about 4° C. and about 37° C., and most preferably about 22° C.

The photoradiation source may be a source of visible radiation or ultraviolet radiation or both. The photoradiation source may be a simple lamp or may consist of multiple lamps radiating at differing wavelengths. The photoradiation source should be capable of delivering from about 1 to at least about 120 J/cm².

Any means for adding the photosensitizer and quencher to the fluid to be decontaminated and for placing the fluid in the photopermeable container known to the art may be used, such means typically including flow conduits, ports, reservoirs, valves, and the like. Preferably, the system includes means such as pumps or adjustable valves for controlling the flow of the quencher and photosensitizer into the fluid to be decontaminated so that its concentration may be controlled at effective levels as described above. In one embodiment, photosensitizer and quencher are mixed with the anticoagulant feed to a blood apheresis system. For endogenous photosensitizers and derivatives having sugar moieties, the pH of the solution is preferably kept low enough, as is known to the art, to prevent detachment of the sugar moiety. The photosensitizer and/or quencher can be added to the fluid to be decontaminated in a pre-mixed aqueous solution, e.g., in water or storage buffer solution. Preferably the photosensitizer and quencher are added to the fluid to be decontaminated as dry medium in powder, pill, tablet or capsule form.

In another embodiment the fluid is placed in a photopermeable container such as a blood bag, e.g. used with the apheresis system described in U.S. Pat. No. 5,653,887, and agitated while exposing to photoradiation. Suitable bags include collection bags as described herein. Collection bags used in the Spectra™ system or Trima™ apheresis system of Gambro BCT, Inc., of Lakewood, Colo., are especially suitable. Shaker tables are known to the art, e.g. as described in U.S. Pat. No. 4,880,788. The bag is equipped with at least one port for adding fluid thereto. In one embodiment the photosensitizer preferably 7,8-dimethyl-10-ribityl-isoalloxazine, and quencher, are added to the fluid-filled bag in dry form as a powder, pill, tablet or capsule. The bag is then placed on a shaker table and agitated under photoradiation until substantially all the fluid has been exposed to the photoradiation. Alternatively, the bag may be prepackaged with the powdered photosensitizer and quencher contained therein. The fluid to be decontaminated may then be added through the appropriate port.

Decontamination systems as described above may be designed as stand-alone units or may be easily incorporated into existing apparatuses known to the art for separating or treating blood being withdrawn from or administered to a patient. For example, such blood-handling apparatuses include the Gambro BCT, Inc., of Lakewood, Colo., Spectra™ or TRIMA® apheresis systems, available from Gambro BCT, Inc., of Lakewood, Colo., or the apparatuses described in U.S. Pat. No. 5,653,887 and U.S. Ser. No. 08/924,519 filed Sep. 5, 1997 (PCT Publication No. WO 99/11305) of Gambro BCT, Inc., of Lakewood, Colo., as well as the apheresis systems of other manufacturers. The decontamination system may be inserted just downstream of the point where blood is withdrawn from a patient or donor, just prior to insertion of blood product into a patient, or at any point before or after separation of blood constituents. The photosensitizer and quencher are added to blood components along with anticoagulant in a preferred embodiment, and separate irradiation sources and cuvettes are placed downstream from collection points for platelets, for plasma and for red blood cells. The use of three separate blood decontamination systems is preferred to placement of a single blood decontamination system upstream of the blood separation vessel of an apheresis system because the lower flow rates in the separate component lines allows greater ease of irradiation. In other embodiments, decontamination systems of this invention may be used to process previously collected and stored blood products.

When red blood cells are present in the fluid being treated, as will be appreciated by those skilled in the art, to compensate for absorption of light by the cells, the fluid may be thinned, exposed to higher energies of radiation for longer periods, agitated for longer periods or presented to photoradiation in shallower containers or conduits than necessary for use with other blood components.

The decontamination method of this invention using endogenous photosensitizers and endogenously-based derivative photosensitizers is exemplified herein using 7,8-dimethyl-10-ribityl isoalloxazine as the photosensitizer, however, any photosensitizer may be used which is capable of being activated by photoradiation to cause inactivation of microorganisms.

It has been observed through immunohematology studies, that cells of blood components treated with photoactive agents which act on membranes have IgG and other plasma proteins associated with the cell membrane. IgG is an immunoglobulin plasma protein that when present is caused to bind with the cells during the photoactivation process.

The presence of IgG and the potential for it to become bound to the membrane of red cells raises potential concerns and difficulties in using photosensitizers to inactivate pathogens in red blood cells. Physiological issues include immediate clearance of the treated red cells by the transfused patients' reticuloendothelial system and complement activation.

Perhaps as important a concern with respect to IgG binding, even if the presence of IgG has no effect on cell survival or product safety, is with respect to the diagnostic implications. After treatment, the IgG bound to the treated cells cannot be removed from the cell membranes by washing the cells; even if extensive washings are performed. Because of the binding of the IgG to the cells, the cells may exhibit a positive test result when direct antiglobulin test (DAT or Coombs') is employed.

The Coombs' test is used to detect antibody on red blood cells. The test uses rabbit antisera to immunoglobulin. When cells coated with IgG are mixed with the rabbit antisera, agglutination occurs. If IgG coated red cells are transfused into a patient, a physician loses one of his important diagnostic tests in understanding hematologic changes in the patient, since patients receiving such a product may exhibit a positive Coombs' test.

The use of quenchers help prevent IgG binding to red blood cells, and any consequent positive DAT results. These quenchers may be added to the blood or blood components to be treated prior to, simultaneously with or after the addition of the pathogen inactivating compound as described above. Preferably, the quencher is added prior to or simultaneously with the pathogen inactivating compound. The quenchers may be added to the biological material to be photoinactivated either alone or in combination with other quenchers.

Preferred for use in this invention are quenchers which substantially do not damage blood components, and in particular do not damage red blood cell function or modify red blood cells after treatment. Also preferred are quenchers which do not substantially interfere with the pathogen inactivating compound. The lack of a substantially damaging effect on red blood cell function may be measured by methods known in the art for testing red blood cell function. For example, the levels of indicators such as intracellular ATP (adenosine 5′-triphosphate), intracellular 2,3-DPG (2,3-diphosphoglycerol) or extracellular potassium may be measured, and compared to an untreated control. Additionally hemolysis, pH, hematocrit, hemoglobin, osmotic fragility, glucose consumption and lactate production may be measured.

Although concentrations of the pathogen inactivating compound and the quenching agent are given above, it is understood that the concentration of the quenching agent may be adjusted as needed in the blood product being treated to produce the desired reduction of unwanted side reactions, while still protecting the property of the material, such as red blood cell function, and also achieving the desired log kill of pathogens. These adjustments are known to one of ordinary skill in the art.

Some quenchers, such as glutathione, may oxidize or otherwise degrade or react over time. For example, when the quencher is a thiol containing compound, the quencher may oxidize to form disulfide dimers. It is preferred to add the quencher to the material at a time and concentration such that the quencher can quench the pathogen inactivating compound before it has substantially degraded or otherwise reacted in situ. The addition of glutathione to the blood or blood component close to the time of addition of the pathogen inactivating compound is advantageous to minimize possible reduction of glutathione concentration, for example, by oxidation or peptidolysis, which may occur, for example in some biological materials, such as plasma.

Although described in connection with viruses, it will be understood that the methods of the present invention are generally also useful to inactivate any biological contaminant found in stored blood or blood products, including bacteria and blood-transmitted parasites. Also monoclonal or polyclonal antibodies directed against specific viral antigens (either coat proteins or envelope proteins) may be covalently coupled with a photosensitizer compound. Other fields of application wherein the present invention may find application include the preparation of non-infectious viral vaccines, therapeutic treatment of immune system disorders by photophoresis, elimination of viable nucleated cells such as leukocytes via the cytotoxicity of nucleic acid binding photosensitizers, and possible treatment for certain accessible cancers and tumors.

In one method of this invention, illumination solutions useful for irradiation of blood and blood components are provided. A preferred illumination solution used in the methods of the invention for red blood cells contains 500 μM riboflavin, 0.9% sodium chloride and 4 mM glutathione. In use, blood or blood components are prepared as described herein or as known in the art. The blood or blood components are combined with an illumination solution and irradiated, as described herein. After the irradiation procedure, the irradiated red blood cells may be stored in a commonly used storage solution, for example, AS3 as described in published PCT application WO 01/94349 (incorporated by reference in its entirety to the amount not inconsistent herewith) to which additional quencher, preferably glutathione, may be added.

Glutathione has many properties that make it particularly useful as a quencher. It is normally present in all cell types. It is not believed substantially to be passively able to pass through the membranes, such as cell membranes or lipid coats, of bacteria and lipid-enveloped viruses. At pH 7, glutathione is charged and in the absence of active transport does not penetrate lipid bilayers to any significant extent.

For batch systems, it is preferred to place the fluid to be decontaminated along with photosensitizer and quencher in bags which are photopermeable or at least sufficiently photopermeable to allow sufficient radiation to reach their contents to activate the photosensitizer. Sufficient photosensitizer is added to each bag to provide inactivation, preferably to provide a photosensitizer concentration of at least about 10 μM, and the bag is agitated while irradiating, preferably at about 1 to about 120 J/cm² for a period of between about 6 and about 36 minutes to ensure exposure of substantially all the fluid to radiation. Preferably, visible light is used. The photosensitizer and quencher may be added in dry form as powder, or a pill, tablet or capsule. The fluid to be decontaminated may contain additives or anticoagulant solutions and the blood product or blood components may be stored in such solutions. As described herein, quencher may be added to the system at any point.

The method preferably uses endogenous photosensitizers, including endogenous photosensitizers which function by interfering with nucleic acid replication. 7,8-dimethyl-10-ribityl isoalloxazine is the preferred photosensitizer for use in this invention. The chemistry believed to occur between 7,8-dimethyl-10-ribityl isoalloxazine and nucleic acids does not proceed via singlet oxygen-dependent processes (i.e. Type II mechanism), but rather by direct sensitizer-substrate interactions (Type I mechanisms). Cadet et al. (1983) J. Chem., 23:420-429, clearly demonstrate the effects of 7,8-dimethyl-10-ribityl isoalloxazine are due to non-singlet oxygen oxidation of guanosine residues. In addition, adenosine bases appear to be sensitive to the effects of7,8-dimethyl-10-ribityl isoalloxazine plus UV light. This is important since adenosine residues are relatively insensitive to singlet oxygen-dependent processes. 7,8-dimethyl-10-ribityl isoalloxazine appears not to produce large quantities of singlet oxygen upon exposure to UV light, but rather exerts its effects through direct interactions with substrate (e.g., nucleic acids) through electron transfer reactions with excited state sensitizer species. Since indiscriminate damage to cells and proteins arises primarily from singlet oxygen sources, this mechanistic pathway for the action of 7,8-dimethyl-10-ribityl isoalloxazine allows greater selectivity in its action than is the case with compounds such as psoralens which possess significant Type II chemistry.

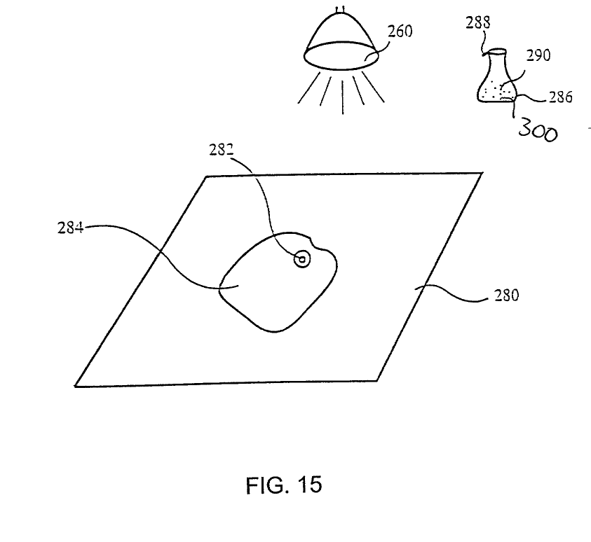

FIG. 15 depicts an embodiment of this invention in which fluid to be decontaminated is placed in a blood bag 284 equipped with an inlet port 282, through which photosensitizer in powder form 284 is added from flask 286 via pour spout 288. Quencher 300 is also added. Shaker table 280 is activated to agitate the bag 284 to dissolve photosensitizer 290 while photoradiation source 260 is activated to irradiate the fluid and photosensitizer in bag 284. Alternatively, the bag can be provided prepackaged to contain photosensitizer and quencher and the fluid is thereafter added to the bag.

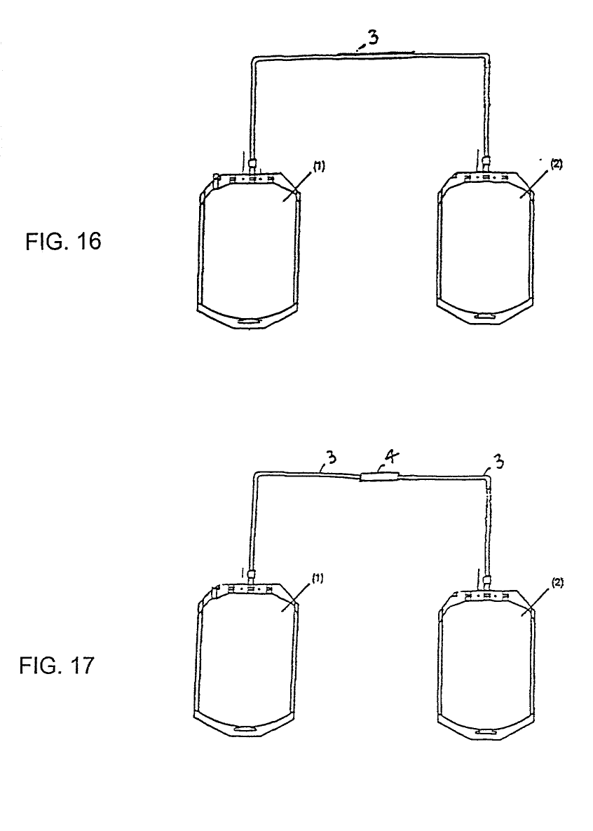

FIGS. 16 and 17 depict an embodiment of this invention in which blood bags or other photopermeable containers used in blood component collection and storage are prepackaged to contain the photosensitizer and quencher in either dry or aqueous form. The additive solutions necessary for storage of blood components are added to the blood bags either separately or together with the separated blood components. Alternatively, the additive solutions can be prepackaged in the same or connected containers in dry or aqueous form, either alone, or together with the photosensitizers necessary for viral inactivation and desired quenchers. The photosensitizer, quencher and blood component additives that are prepackaged within the bags may be in a dry powder form, a pill, capsule, tablet form, liquid form, or in various combinations thereof. In describing this invention, the term dry solid or dry form envisions the components being in a loose powdered state or in a solid state such as a pill, capsule, tablet, or any equivalent thereof known to one skilled in the art.

As shown in FIG. 16, a first blood storage bag 1 and a second blood storage bag 2 are connected together by flexible tubing 3. The first and second bags 1 and 2 could also have a small container 4 located between the two blood bags via flexible tubing 3, as shown in FIG. 17. The container 4 could be another bag, a flask, a reservoir, a small cylinder or any similar container known in the art. The small container 4 of FIG. 17 or the tubing 3 itself of FIG. 16 could contain certain forms of prepackaged components, in a manner similar to that of the two blood bags 1 and 2.

In one embodiment, the photosensitizer, quencher, and either blood additive components or physiological saline are prepackaged in a first bag 1. Glucose or another nutrient could optionally also be prepackaged in bag 1. The blood additive components, quencher and photosensitizer may be in a dry solid or a liquid form. If dry form is used, a solution or preferably saline solution may be added to the bag through a port. Upon addition of the separated blood component to the first bag 1 through a port, the resulting media containing blood component, photosensitizer, quencher, glucose and additive solution move via the flexible tubing 3 into a second bag 2 optionally containing prepackaged phosphate or other enhancer in either a dry solid or liquid form. The second bag 2 is then disconnected from the first bag 1, mixed, and irradiated. It should be noted however, that either the first bag or the second bag could be irradiated as long as the irradiation is done after the addition of the photosensitizer.

In another embodiment, shown in FIG. 17, the first bag 1 contains prepackaged additive solution either in solid or liquid form. Upon addition of the blood component, the resulting media including the blood component or components, flows through the tubing 3 or small container 4 into the second bag 2. In this embodiment, phosphate in either a solid or liquid form is located within the tubing 3 or small container 4. When the mixture flows through the tubing 3 or container 4, the phosphate dissolves upon contact into the mixture. Upon reaching the second bag 2, the media and dissolved phosphate mixture comes in contact with the prepackaged glucose, quencher and photosensitizer in bag 2, either in a solid or liquid form. The second bag 2 is then disconnected from the first bag 1, mixed, and irradiated.

In an alternative embodiment contemplated by this invention, the first bag 1 may contain quencher, photosensitizer with or without additive solution, and also with or without glucose and the tubing 3 or small container 4 may contain phosphate. In another embodiment, the first bag 1 contains additive solution, the photosensitizer and quencher are in the tubing 3 or container 4, and phosphate and/or glucose is in the second bag 2. It is also contemplated that the photosensitizer and quencher are prepackaged in the first bag 1, and phosphate and/or glucose is in the tubing 3 or container 4. The use of a frangible connection (not shown) between the first bag 1 and the container 4 is further envisioned for use with this invention. The frangible connector would be manually snapped to allow fluid or media to reach the constituent in the tubing 3 or container 4 when desired.

It is understood that there can be numerous variations of this invention. The additive solutions and other constituents can be prepackaged in either bag in aqueous or in dry solid form as well as within the small container 4. In this system for photoinactivating contaminants within the blood it is preferable to add additional phosphate and a nutrient such as glucose to a known additive phosphate and glucose free additive solution. It is also desirable to keep the phosphate separate from the photosensitizer and quencher and also preferable to keep the phosphate separate from the glucose during bag system sterilization. If the additive solution contains a phosphate and/or glucose it is contemplated that it may be unnecessary to add an additional amount of such constitutents. The above are only a few examples and are not meant to be limiting. It is understood that other combinations of the constituents are also contemplated.

### Example 1

A platelet concentrate was mixed with the platelet additive solution Isolyte S at a ratio of 10:90 platelet concentrate:Isolyte S. Mixtures of platelet concentrates and platelet additive solutions are referred to herein as in “media.” Platelet concentrate without additive solution is referred to herein as in “plasma.”

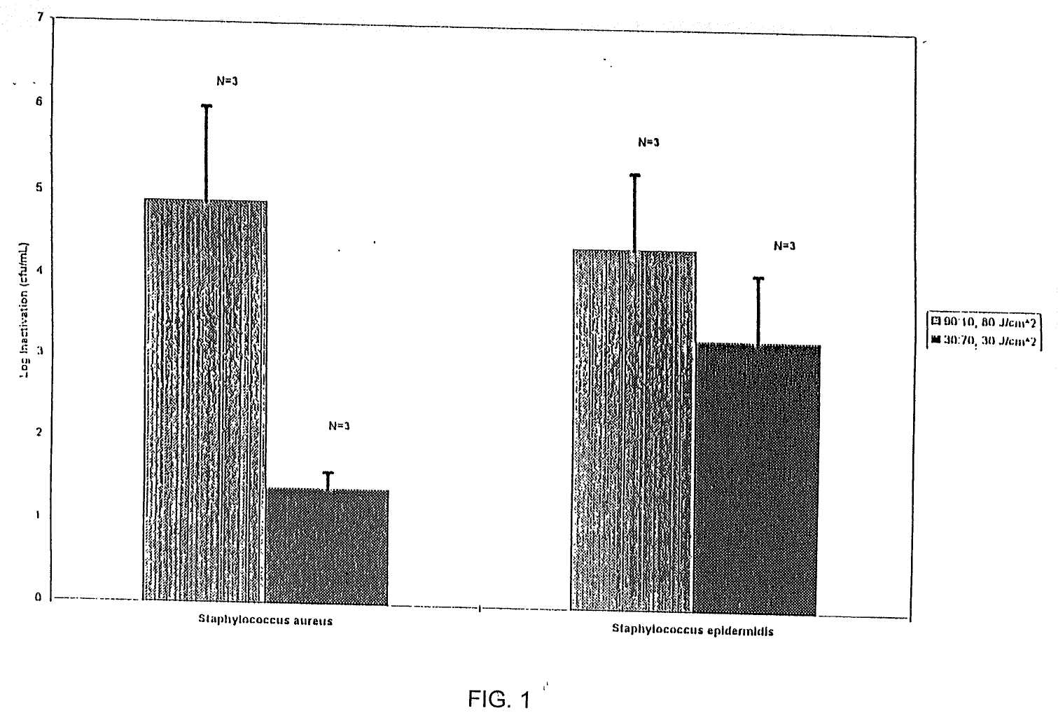

To platelet concentrate and to 70:30 media was added 10 μM of 7,8-dimethyl-10-ribityl isoalloxazine. The platelet concentrate and media were spiked with S. aureus or S. epidermidis, and irradiated at 80 J/cm² and 30 J/cm² and inactivation measured as above. Results are shown in FIG. 1.

### Example 2

To plasma concentrate as described in Example 1 contained in a standard blood bag was added 25 μM 7,8-dimethyl-10-ribityl isoalloxazine in powder form. The bag was spiked with bacteria as shown in Table 1, agitated and exposed to 120 J/cm² radiation. Inactivation results are set forth in Table 1.

TABLE 1

| Pathogen | Log Inactivation (cfu/mL) |
|---|---|
| S. aureus | 1.7 Logs |
| S. epidermidis | 3.5 Logs |
| P. aeruginosa | 3.6 Logs |
| E. coli | 4.1 Logs |

### Example 3

To platelet concentrate as described in Example 1 was added 7,8-dimethyl-10-ribityl isoalloxazine, alloxazine mononucleotide, or 7-8-dimethyl alloxazine, followed by spiking with S. aureus or S. epidermidis, and irradiation at 80 J/cm². Inactivation results are shown in Table 2.

TABLE 2

| | Log Inactivation (cfu/mL) | |
|---|---|---|
| | Staphylococcus | Staphylococcus |
| | aureus | epidermidis |
| 7,8-dimethyl-10-ribityl isoalloxazine, | 1.9 Logs | 4.1 Logs |
| 10 μM | | |
| alloxazine mononucleotide, 10 μM | 1.6 Logs | 5.6 Logs |
| 7-8-dimethyl alloxazine, 7 μM | 1.6 Logs | 2.9 Logs |

### Example 4

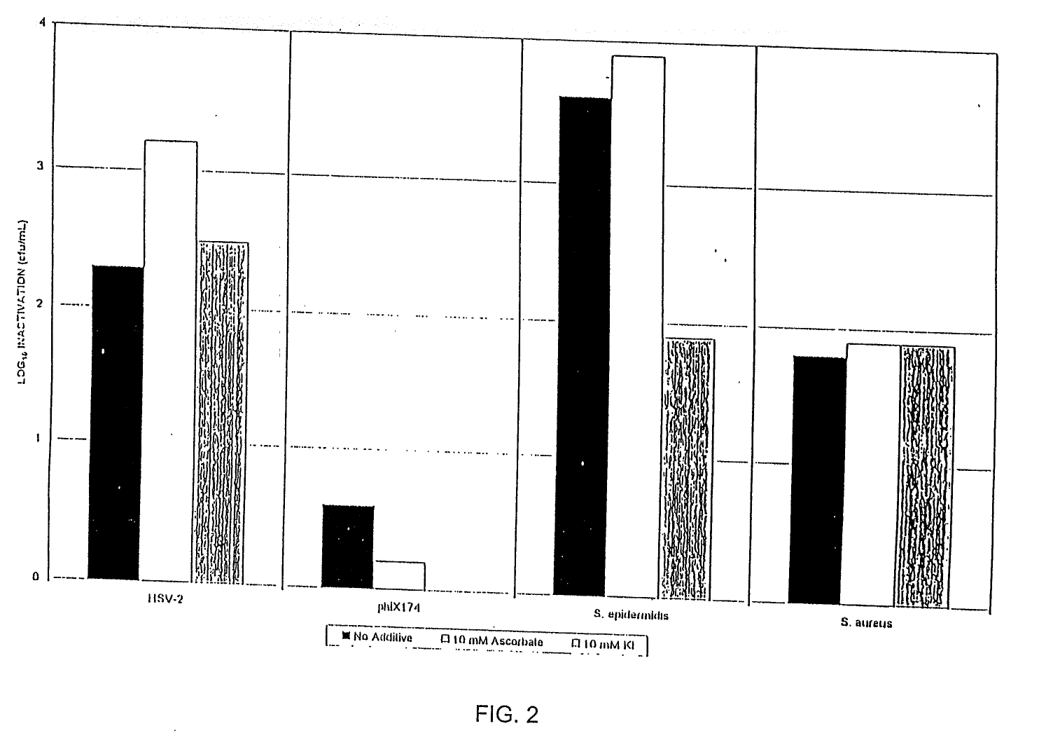

To platelet concentrate of Example 1 was added 10 μM 7,8-dimethyl-10-ribityl-isoalloxazine. Aliquots contained no additive, 10 mM ascorbate or 10 mM KI as a “quencher” or antioxidant. The solutions were spiked with HSV-2, X174, S. epidermidis or S. aureus and irradiated at 80 J/cm². Results are shown in FIG. 2.

### Example 5

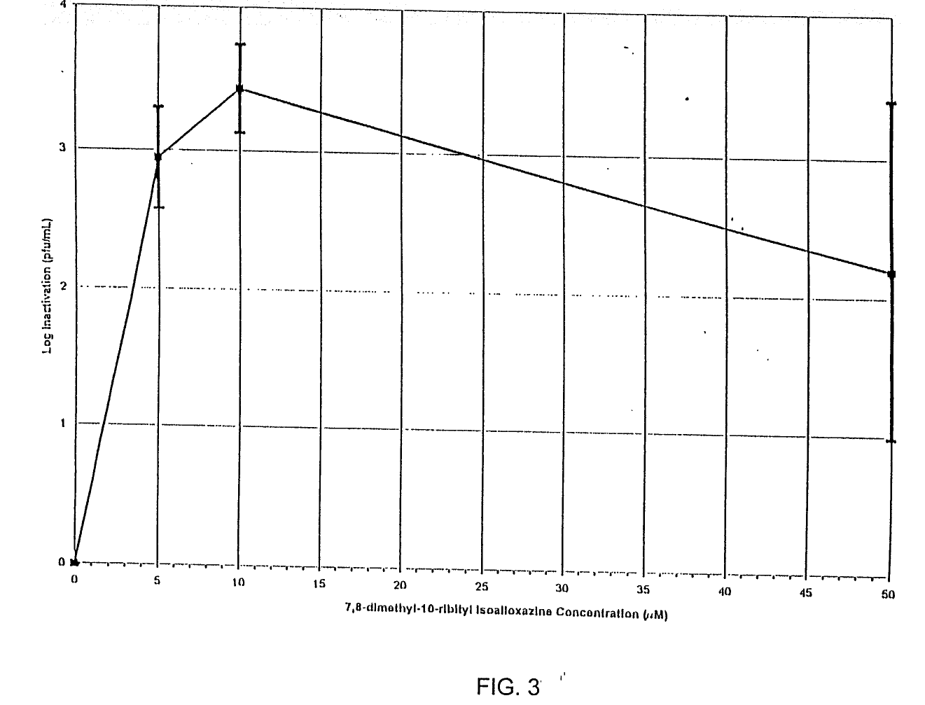

To platelet concentrates of Example 1 were added varying concentrations of 7,8-dimethyl-10-ribityl-isoalloxazine. These solutions were spiked with herpes simplex virus type II (HSV-II), a double-stranded DNA envelope virus. Irradiation was done at 80 J/cm². The experiment was replicated three times. In all three trials complete inactivation was achieved. Results are shown in FIG. 3.

### Example 6

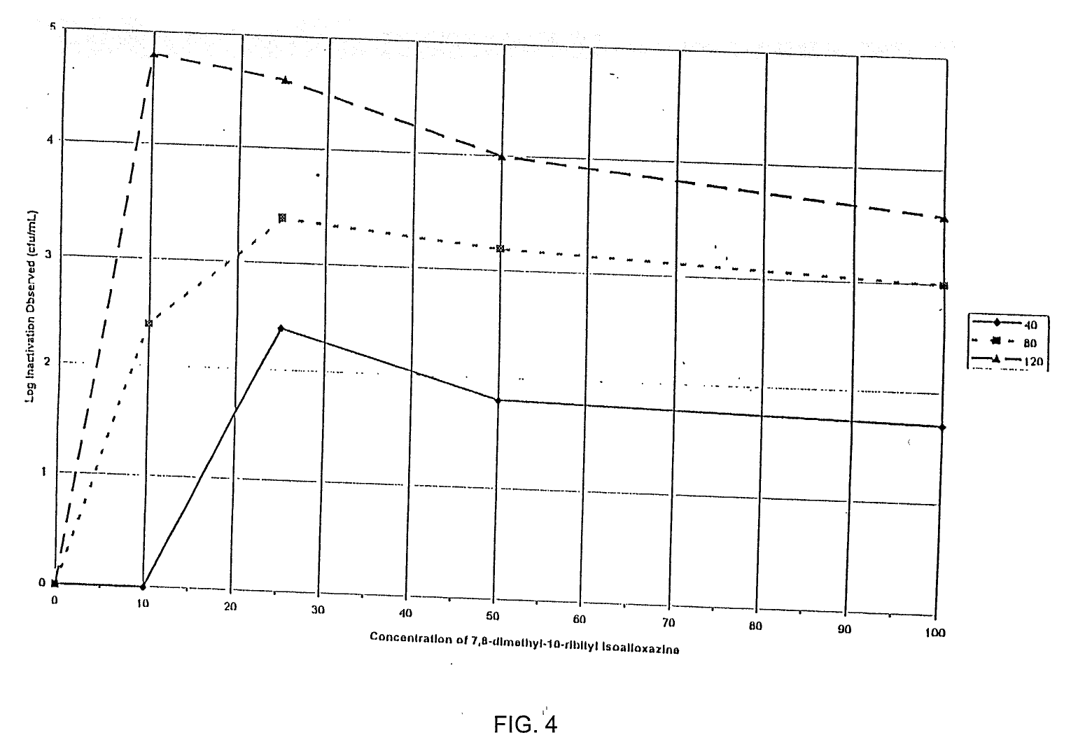

The protocol of Example 5 was followed using S. epidermidis instead of HSV II at energies of irradiation of 40, 80 and 120 J/cm². Inactivation results are shown in FIG. 4.

### Example 7

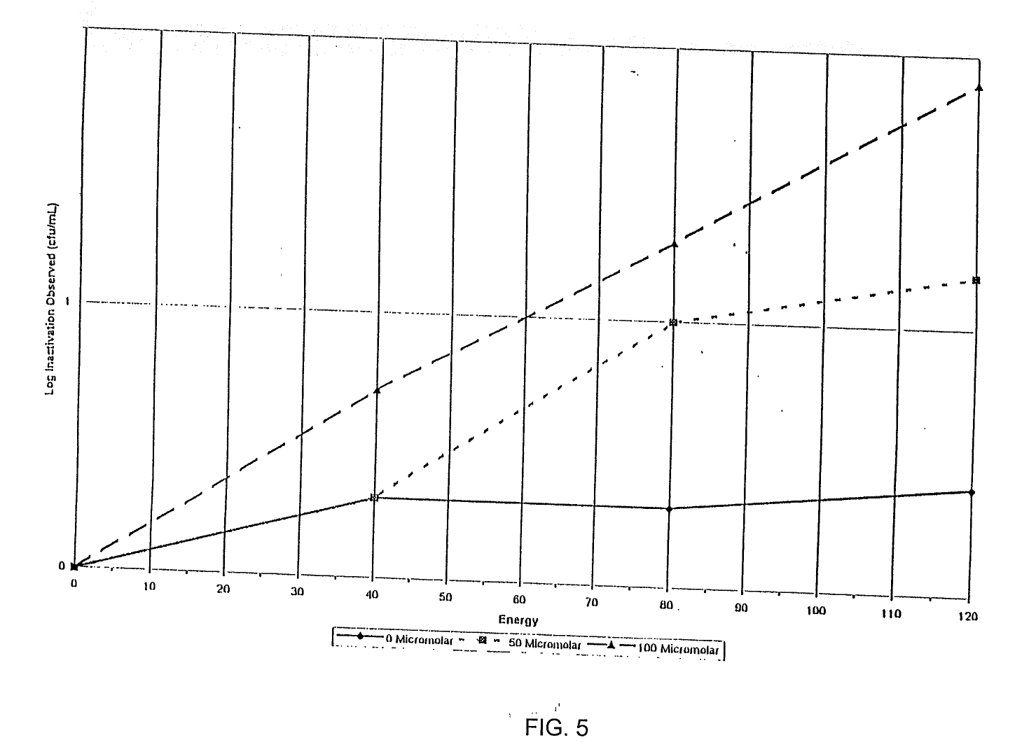

The protocol of Example 5 was followed using Φ X174, a single stranded DNA bacteriophage, at varying concentrations of 7,8-dimethyl-10-ribityl-isoalloxazine and energies of irradiation. Inactivation results are shown in FIG. 5.

### Example 8

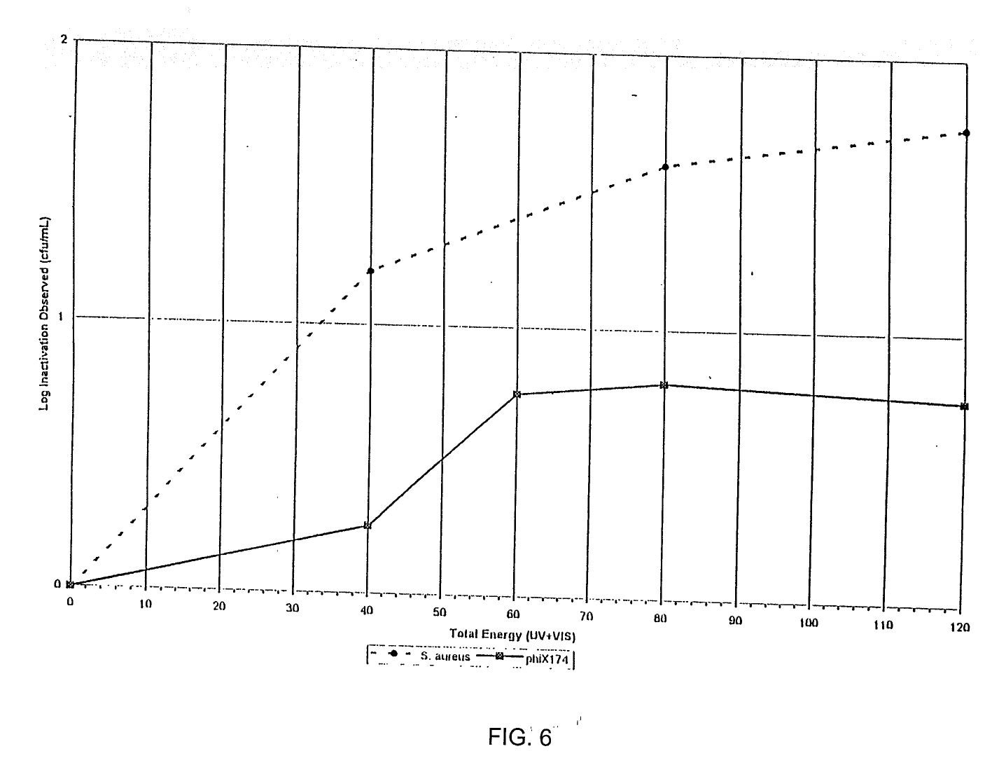

To platelet concentrates of Example 1 was added 10 μM 7,8-dimethyl-10-ribityl-isoalloxazine. These were spiked with S. aureus or Φ X174 and irradiated at varying energies of irradiation with a 50:50 mixture of visible and ultraviolet light. Inactivation results are shown in FIG. 6.

### Example 9

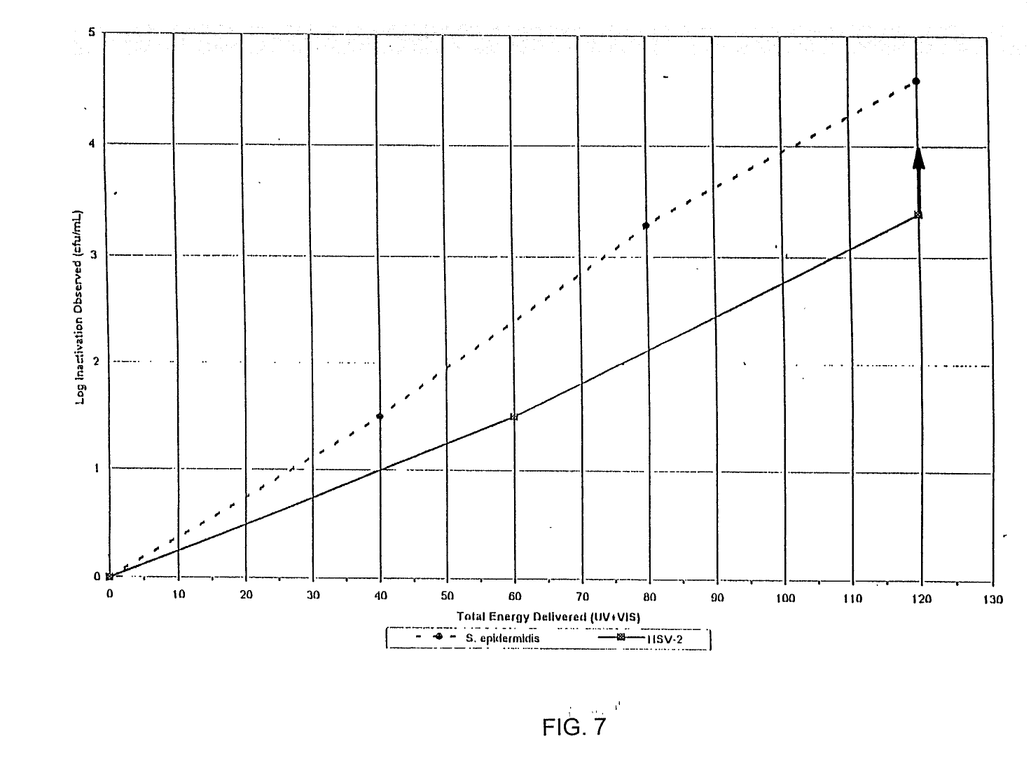

The protocol of Example 8 was followed using S. epidermidis and HSV-II as the microorganisms. A 50:50 mixture of ultraviolet and visible light was supplied by DYMAX light source. Inactivation results are shown in FIG. 7.

### Example 10

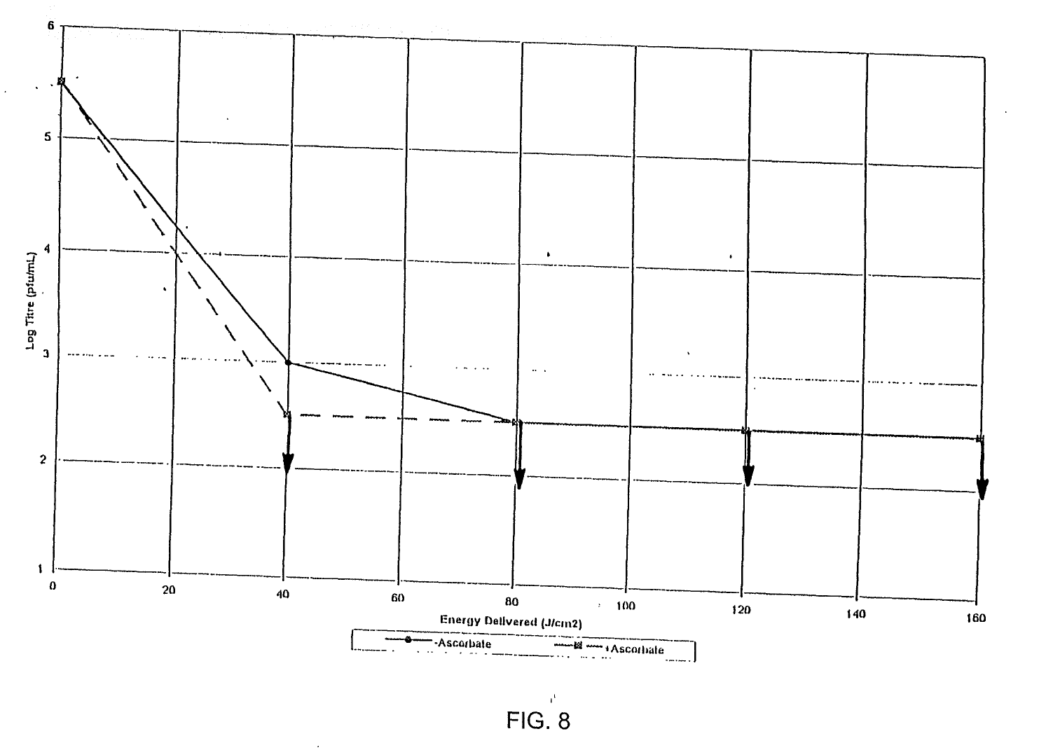

To platelet concentrate of Example 1 was added 10 μM 7,8-dimethyl-10-ribityl-isoalloxazine in powdered form. Tests with and without added ascorbate were conducted. 150 ml of the test solutions were placed in a Spectra™ blood bag and shaken and exposed to varying energies of irradiation using 50:50 visible:ultraviolet light. After receiving 40 J/cm², the contents of each bag were transferred to a new bag to avoid errors due to microorganisms which may have remained in the spike port of the bag. Inactivation results are shown in FIG. 8. Downward arrows indicate inactivation to the level it was possible to detect (2.5 log titre).

### Example 11

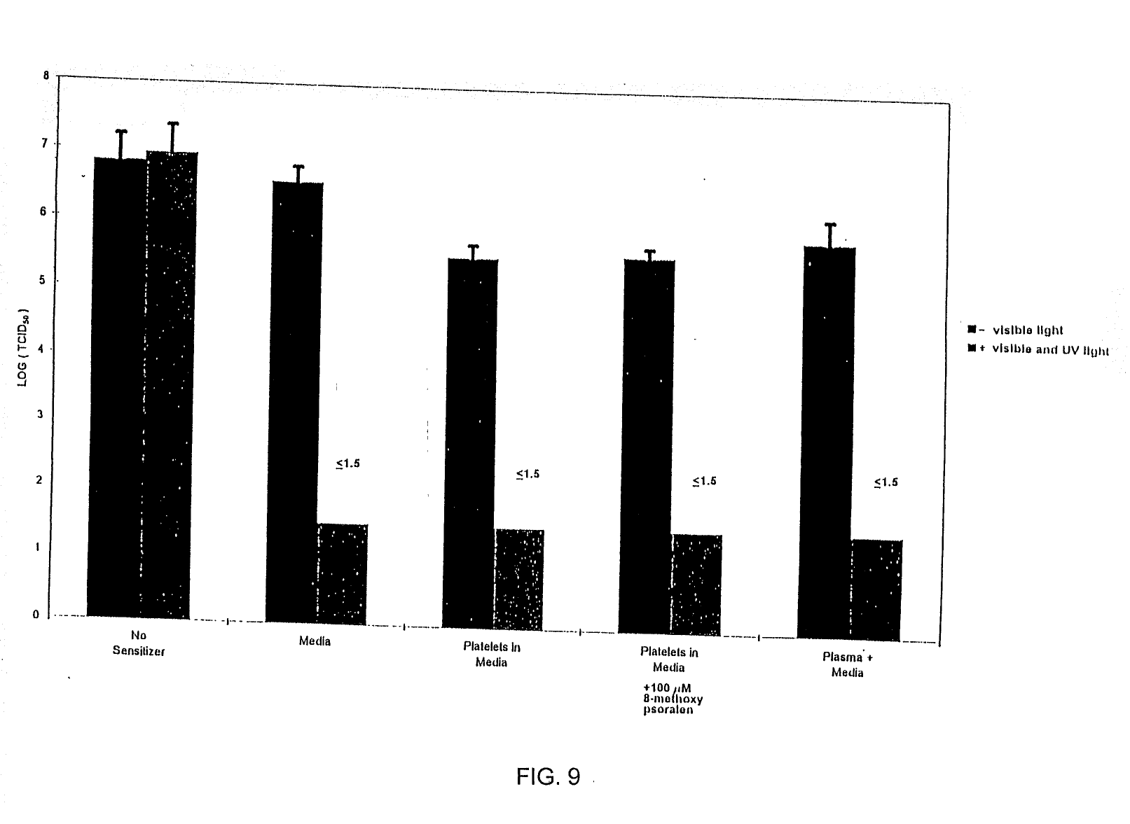

To platelet concentrate of Example 1 and platelet concentrate in Isolyte S at 30:70 platelet concentrate:Isolyte S, was added 20 μM 7,8-dimethyl-10-ribityl-isoalloxazine. These were spiked with vaccinia virus, a double stranded DNA envelope virus, and exposed to 60 J/cm² visible light or mixed (50:50) visible and ultraviolet light using a DYMAX 2000 UV light source for 30 minutes. The limit of detection was 1.5 logs. Inactivation results are shown in FIG. 9. Comparisons were done using no photosensitizer, photosensitizer in Isolyte S media alone, platelets in Isolyte S media, platelets in Isolyte S media using 8-methoxy psoralen instead of 7,8-dimethyl-10-ribityl-isoalloxazine, and platelet concentrate in Isolyte media (30:70).

### Example 12

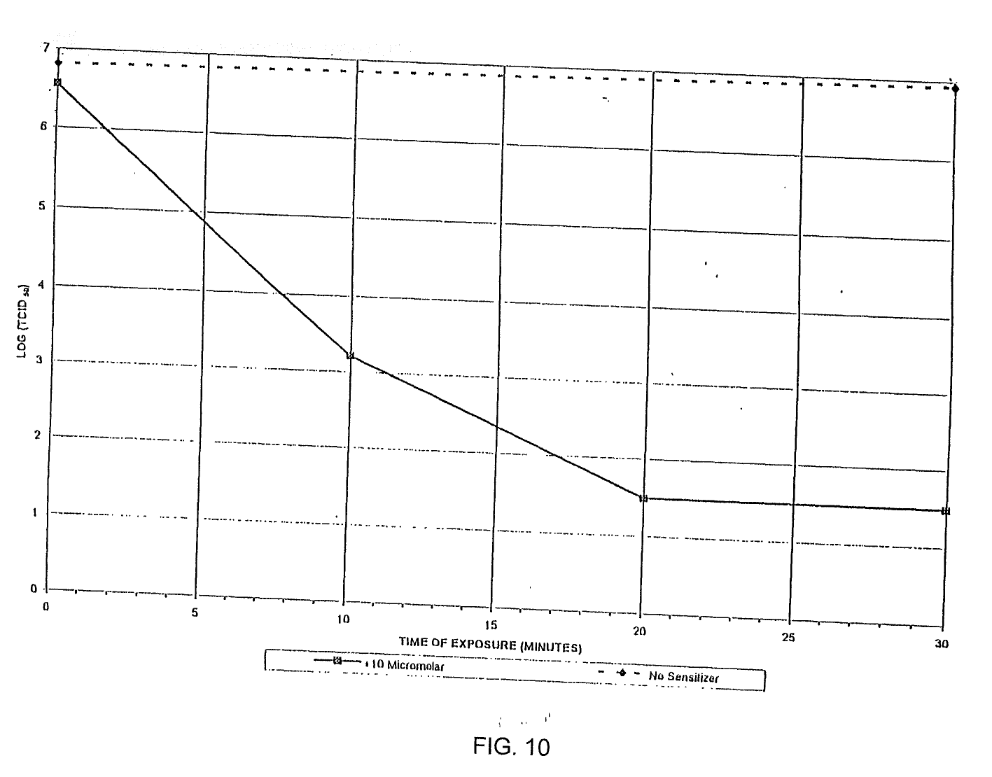

Samples of platelet concentrate in Isolyte S media 30:70, with and without 10 μM 7,8-dimethyl-10-ribityl-isoalloxazine were spiked with vaccinia virus and irradiated at 60 J/cm² with 50:50 visible:UV light for varying periods of time and inactivation results compared as shown in FIG. 10.

### Example 13

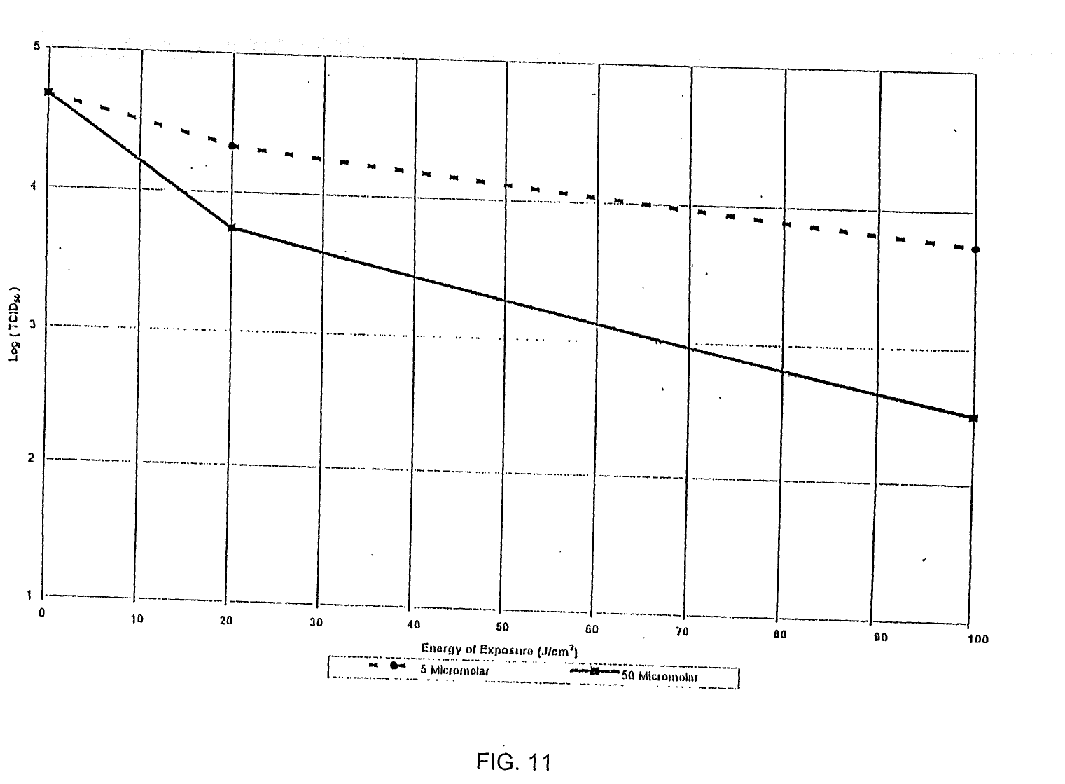

To samples of platelet concentrate as described in Example 1 were added 5 μM or 50 μM 7,8-dimethyl-10-ribityl-isoalloxazine. Samples were spiked with HIV 1. Using the cuvette flow cell shown in FIG. 1, samples were irradiated with 50:50 visible:UV light at varying energies using an EFOS light system. Inactivation results are shown in FIG. 11.

### Example 14

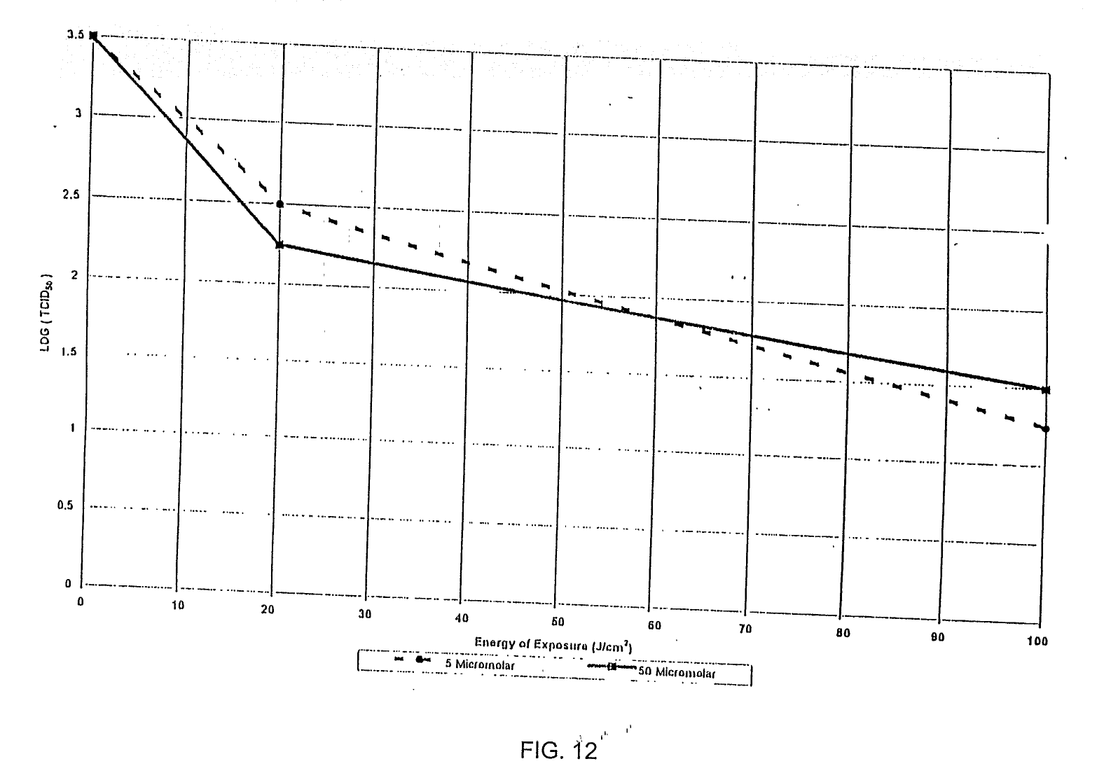

HIV-infected ACH-2 cells were added to samples of platelet concentrate described in Example 1.5 or 50 μM of 7,8-dimethyl-10-ribityl-isoalloxazine were added to the samples. The protocol of Example 13 was followed, and inactivation results are shown in FIG. 12. The presence of HIV was assayed by its cytopathic effect on test cells.

### Example 15

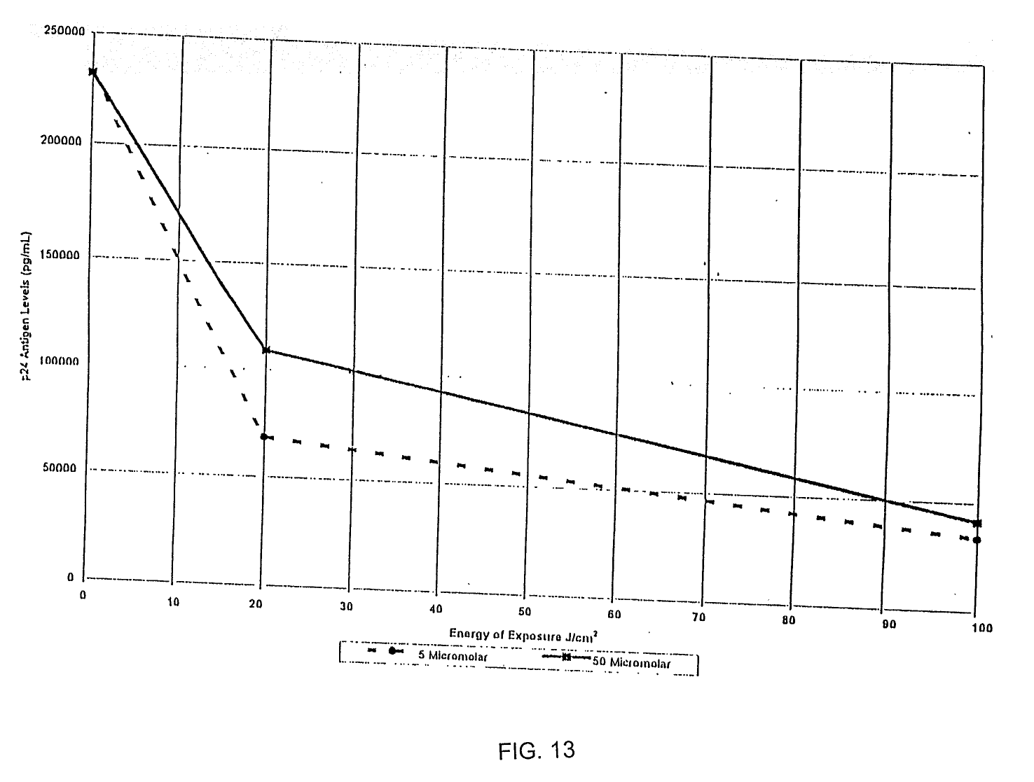

The protocol of Example 14 was followed and the presence of HIV assayed by quantifying the level of P24 antigen production. Inactivation results are shown in FIG. 13.

### Example 16

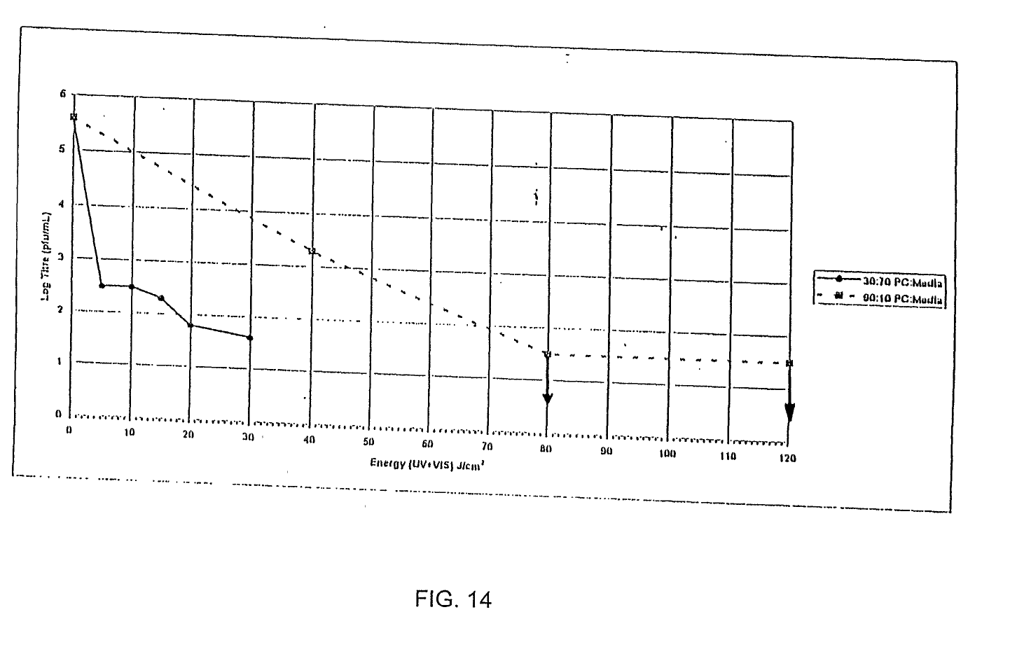

To samples of platelet concentrate as described in Example 1 and media containing 30% platelet concentrate and 70% PASIII media were added 6 mM ascorbate and 14 μM 7,8-dimethyl-10-ribityl-isoalloxazine. Samples were spiked with HSV-II. Inactivation results are shown in FIG. 14 and Table 3.

TABLE 3

| | Energy | 30:70 | Energy | 90:10 |
|---|---|---|---|---|
| Time | (UV + VIS) | PC:Media | (UV + VIS) | PC:Media |
| (Minutes) | J/cm² | log virus titre | J/cm² | log virus titre |
| 0.0 | 0 | 5.6 | 0 | 5.6 |
| 1.5 | 5 | 2.5 | 40 | 3.3 |
| 3.0 | 10 | 2.5 | 80 | 1.5 |
| | | | | No Detectable |
| | | | | Virus |
| 4.5 | 15 | 2.3 | 120 | 1.5 |
| | | | | No Detectable |
| | | | | Virus |
| 6.0 | 20 | 1.8 | | |
| 9.0 | 30 | 1.6 | | |
| 12.0 | 40 | | | |
| 24.0 | 80 | | | |
| 36.0 | 120 | | | |

### Example 17

This example compares novel blood component additive solutions for addition to platelets separated from whole blood. Six commercially available solutions were used: PAS II, PSMI-pH, PlasmaLyte A, SetoSol, PAS III, and PAS (designated PSS 1-6, respectively, in Table 4). To each known solution was added an effective amount of an endogenous photosensitizer, 7,8-dimethyl-10-ribityl isoalloxazine and an effective amount of a quencher. The photosensitizer may be present in the various solutions at any desired concentration from about 1 μM up to the solubility of the photosensitizer in the fluid, or dry medium, and preferably about 10 μM. For 7,8-dimethyl-10-ribityl isoalloxazine a concentration range between about 1 μM and about 160 μM is preferred, preferably about 10 μM. The composition of each solution is shown in Table 4 below, and varies in the amount of blood component additives present. The blood additive components may be in a physiological solution, as well as a dry medium adapted to be mixed with a solvent, including tablet, pill or capsule form.

TABLE 4

| Blood | | | | | | |
|---|---|---|---|---|---|---|
| Component | Platelet Storage Solution | | | | | |
| Additive | PSS 1 | PSS 2 | PSS 3 | PSS 4 | PSS 5 | PSS 6 |
| KCl (mM) | | 5.0 | 5.0 | 5.0 | 5.1 | |
| CaCl₂ (mM) | | | | | 1.7 | |
| MgCl₂ (mM) | | | 3.0 | 3.0 | | |
| MgSO₄ (mM) | | | | | 0.8 | |
| sodium citrate | 10.0 | 23.0 | 23.0 | 17.0 | 15.2 | 12.3 |
| (mM) | | | | | | |
| citric acid | | | | | 2.7 | |
| (mM) | | | | | | |
| NaHCO₃ (mM) | | | | | 35.0 | |
| Na₂HPO₄ | | 25.0 | | 25.0 | 2.1 | 28.0 |
| (mM) | | | | | | |
| sodium acetate | 30.0 | | 27.0 | 23.0 | | 42.0 |
| (mM) | | | | | | |
| sodium gluco- | | | 23.0 | | | |
| nate (mM) | | | | | | |
| glucose (mM) | | | | 23.5 | 38.5 | |
| maltose (mM) | | | | 28.8 | | |
| 7,8-dimethyl | 10.0 | 10.0 | 10.0 | 10.0 | 10.0 | 10.0 |
| 10-ribityl | | | | | | |
| isoalloxazine | | | | | | |
| (μM) | | | | | | |
| quencher (mM) | variable | variable | variable | variable | variable | variable |

In Example 17, the platelet storage solution PSS 1 comprises a physiological saline solution, tri-sodium citrate at a concentration of approximately about 10 mM, sodium acetate at a concentration of approximately about 30 mM, 7, 8-dimethyl-10-ribityl isoalloxizine at a concentration of about 10 μM, and an effective amount of a quencher.

In Example 17, the platelet storage solution PSS 2 comprises a physiological saline solution, potassium chloride at a concentration of approximately about 5 mM, tri-sodium citrate at a concentration of approximately about 23 mM, a mixture of monosodium phosphate and dibasic sodium phosphate at a concentration of approximately about 25 mM, and 7, 8-dimethyl-10-ribityl isoalloxizine at a concentration of about 10 μM, and an effective amount of a quencher.

In Example 17, the platelet storage solution PSS 3 comprises a physiological saline solution, potassium chloride at a concentration of approximately about 5 mM, magnesium chloride at a concentration of approximately about 3 mM, tri-sodium citrate at a concentration of approximately about 23 mM, sodium acetate at a concentration of approximately about 27 mM, sodium gluconate at a concentration of approximately about 23 mM, 7, 8-dimethyl-10-ribityl isoalloxizine at a concentration of about 10 μM, and an effective amount of a quencher.

In Example 17, the platelet storage solution PSS 4 comprises a physiological saline solution, potassium chloride at a concentration of approximately about 5 mM, magnesium chloride at a concentration of approximately about 3 mM, tri-sodium citrate at a concentration of approximately about 17 mM, sodium phosphate at a concentration of approximately about 25 mM, sodium acetate at a concentration of approximately about 23 mM, glucose at a concentration of approximately about 23.5 mM, maltose at a concentration of approximately about 28.8 mM, 7, 8-dimethyl-10-ribityl isoalloxizine at a concentration of about 10 μM, and an effective amount of a quencher.

In Example 17, the platelet storage solution PSS 5 comprises a physiological saline solution, potassium chloride at a concentration of approximately about 5.1 mM, calcium chloride at a concentration of approximately about 1.7 mM, magnesium sulfate at a concentration of approximately about 0.8 mM, tri-sodium citrate at a concentration of approximately about 15.2 mM, citric acid at a concentration of approximately about 2.7 mM, sodium bicarbonate at a concentration of approximately about 35 mM, sodium phosphate at a concentration of approximately about 2.1 mM, glucose at a concentration of approximately about 38.5 mM, 7,8-dimethyl-10-ribityl isoalloxizine at a concentration of about 10 μM, and an effective amount of a quencher.

In Example 17, the platelet storage solution PSS 6 comprises a physiological saline solution, tri-sodium citrate at a concentration of approximately about 12.3 mM, sodium phosphate at a concentration of approximately about 28 mM, sodium acetate at a concentration of approximately about 42 mM, 7,8-dimethyl-10-ribityl isoalloxizine at a concentration of about 10 μM, and an effective amount of a quencher.

In an aspect of the preferred embodiment, physiologic saline may be replaced with a solvent comprising water and an effective amount of sodium chloride.

In the preferred embodiment, the blood additive solution would comprise a commercially available product for example PAS II or T-Sol (which has the same ingredients as PAS II) and an effective amount of a nutrient such as glucose, an enhancer such as phosphate, 7,8-dimethyl-10-ribityl isoalloxazine in a pill or a dry medium form, and an effective amount of a quencher.

Also, the blood additive solution could comprise an other additive solution including an effective amount of 7, 8-dimethyl-10-ribityl isoalloxazine in a liquid, pill or dry medium form. PSS 7, PSS 8 and PSS 9 are examples of such blood additive solutions set forth in Table 5 below.

TABLE 5

| | Platelet Storage Solution | | |
|---|---|---|---|
| Blood Component Additive | PSS 7 | PSS 8 | PSS 9 |
| NaCl (mM) | 115.0 | 78.3 | 68.5 |
| potassium cloride (mM) | | 5.7 | 5.0 |
| MgCl₂ (mM) | | 1.7 | 1.5 |
| sodium citrate (mM) | 10.0 | | |
| sodium phosphate (monobasic) | 6.2 | 5.4 | 8.5 |
| sodium phosphate (dibasic) | 19.8 | 24.6 | 21.5 |
| sodium acetate (mM) | 30.0 | 34.3 | 30.0 |
| 7,8-dimethyl 10-ribityl isoalloxazine (μM) | 14.0 | variable | 14.0 |
| quencher (mM) | variable | variable | variable |

As described in Table 5, PSS 7 was prepared in RODI water and sodium chloride at a concentration of approximately 115 mM, sodium citrate at a concentration of approximately 10.0 mM, sodium phosphate (monobasic) at a concentration of approximately 6.2 mM, sodium phosphate (dibasic) at a concentration of approximately 19.8 mM, sodium acetate at a concentration of approximately 30.0 mM, 7,8-dimethyl 10-ribityl isoalloxazine at a concentration of approximately 14.0 μM, and an effective amount of a quencher. The solution has a pH of 7.2.

PSS 8 was prepared in RODI water and comprises and sodium chloride at a concentration of approximately 78.3 mM, potassium chloride at a concentration of approximately 5.7 mM, magnesium chloride at a concentration of approximately 1.7 mM, sodium phosphate (monobasic) at a concentration of approximately 5.4 mM, sodium phosphate (dibasic) at a concentration of approximately 24.6 mM, sodium acetate at a concentration of approximately 34.3 mM, a variable concentration of 7,8-dimethyl 10-ribityl isoalloxazine, and an effective amount of a quencher. The solution has a pH of 7.4, and an osmolarity of 297 mmol/kg.

PSS 9 was prepared in RODI water and comprises and sodium chloride at a concentration of approximately 68.5 mM, potassium chloride at a concentration of approximately 5.0 mM, magnesium chloride at a concentration of approximately 1.5 mM, sodium phosphate (monobasic) at a concentration of approximately 8.5 mM, sodium phosphate (dibasic) at a concentration of approximately 21.5 mM, sodium acetate at a concentration of approximately 30.0 mM, 7,8-dimethyl 10-ribityl isoalloxazine at a concentration of approximately 14.0 μM, and an effective amount of a quencher. The solution has a pH of 7.2, and an osmolarity of 305 mmol/kg.

It is understood that in PSS 7, PSS 8 and PSS 9 the RODI water and sodium chloride can be replaced with a saline solution.

### Example 18

This example compares blood component additive solutions for addition to red blood cells separated from whole blood. Five commercially available red blood cell additive solutions were considered: AS-1, AS-3, AS-5, SAGM, and MAP (designated AS1, AS2, AS3, AS4 and AS5, respectively in Table 6). To each known solution was added an effective amount of an endogenous photosensitizer, 7,8-dimethyl-10-ribityl isoalloxazine, and an effective amount of a quencher. The photosensitizer may be present in the various solutions at any desired concentration from about 1 μM up to the solubility of the photosensitizer in the fluid, or dry medium, and preferably about 10 μM. The quencher may be present in a range of 0.05 mM up to a concentration of about 100 mM. The preferred range is between about 0.1 to about 20 mM. For 7,8-dimethyl-10-ribityl isoalloxazine a concentration range between about 1 μM and about 160 μM is preferred, preferably about 10 μM. The composition of each additive solution is shown in Table 6 below, and varies in the amount of blood component additives present. The red blood cell additive solution components may be in a physiological solution, a dry medium adapted to be mixed with a solvent, including in tablet, pill or capsule form as described above.

In Example 18, the red blood cell additive solution AS 1 comprises a physiological saline solution, dextrose at a concentration of approximately about 122.09 mM, adenine at a concentration of approximately about 2 mM, mannitol at a concentration of approximately about 41.16 mM, 7,8-dimethyl-10-ribityl isoalloxazine at a concentration of about 10 μM, and an effective amount of a quencher.

TABLE 6

| BLOOD COMPONENT | BLOOD ADDITIVE SOLUTIONS | | | | |
|---|---|---|---|---|---|
| ADDITIVE (MM) | AS 1 | AS 2 | AS 3 | AS 4 | AS 5 |
| dextrose (mM) | 122.09 | 61.04 | 49.94 | 49.94 | |
| adenine v (mM) | 2.00 | 2.22 | 2.22 | 1.25 | 0.10 |
| NaH₂PO₄H₂O (mM) | | 23.00 | | | 7.80 |
| mannitol (mM) | 41.16 | | 28.81 | 28.81 | 79.91 |
| sodium citrate (mM) | | 19.99 | | | 6.00 |
| glucose (mM) | | | | | 39.96 |
| citric acid (mM) | | 2.19 | | | |
| 7,8-dimethyl-10-ribityl | 10.0 | 10.0 | 10.0 | 10.0 | 10.0 |
| isoalloxanzine (μM) | | | | | |
| quencher (mM) | variable | variable | variable | variable | variable |

In Example 18, the red blood cell additive solution AS 2 comprises a physiological saline solution, dextrose at a concentration of approximately about 61.04 mM, adenine at a concentration of approximately about 2.22 mM, sodium phosphate (monobasic) at a concentration of approximately about 23 mM, sodium citrate at a concentration of approximately 19.99, and citric acid at a concentration of about 2.19 mM, 7,8-dimethyl-10-ribityl isoalloxazine at a concentration of about 10 μM, and an effective amount of a quencher.

The red blood cell additive solution AS 3 comprises a physiological saline solution, dextrose at a concentration of approximately about 49.94 mM, adenine at a concentration of approximately about 2.22 mM, mannitol at a concentration of approximately about 28.81 mM, 7,8-dimethyl-10-ribityl isoalloxazine at a concentration of about 10 μM, and an effective amount of a quencher.

The red blood cell additive solution AS 4 comprises a physiological saline solution, dextrose at a concentration of approximately about 49.94 mM, adenine at a concentration of approximately about 1.25 mM, mannitol at a concentration of approximately about 28.81 mM, 7,8-dimethyl-10-ribityl isoalloxazine at a concentration of about 10 μM, and an effective amount of a quencher.

The red blood cell additive solution AS 5 comprises a physiological saline solution, adenine at a concentration of approximately about 0.10 mM, sodium phosphate (monobasic) at a concentration of approximately about 7.80 mM, mannitol at a concentration of approximately about 79.91 mM, sodium citrate at a concentration of approximately about 6 mM, glucose at a concentration of approximately about 39.96 mM, 7,8-dimethyl-10-ribityl isoalloxazine at a concentration of about 10 μM, and an effective amount of a quencher.

In addition, the present invention further contemplates the addition of a red blood cell anticoagulant-based solution to the separated red blood cells. Five commercially available anticoagulant-based solutions were considered: CPD, CP2D, CPDA-1, ACD-A, and ACD-B (designated ABS1, ABS2, ABS3, ABS4 and ABS5 respectively, in Table 7). To each solution was added an effective amount of an endogenous photosensitizer, 7,8-dimethyl-10-ribityl isoalloxazine and an effective amount of a quencher. The photosensitizer may be present in the various solutions at any desired concentration from about 1 μM up to the solubility of the photosensitizer in the fluid, or dry medium, and preferably about 10 μM. For 7,8-dimethyl-10-ribityl isoalloxazine a concentration range between about 1 μM and about 160 μM is preferred, preferably about 10 μM. The composition of each solution is shown in Table 7 below, and varies in the amount of blood component additives present. The blood additive components may be in a physiological solution, a dry medium adapted to be mixed with a solvent, or in tablet, pill or capsule form as described above.

TABLE 7

| Blood component | Anticoagulant-Based Solution | | | | |
|---|---|---|---|---|---|
| additive (mM) | ABS 1 | ABS 2 | ABS 3 | ABS 4 | ABS 5 |
| sodium citrate (mM) | 89.59 | 89.59 | 89.59 | 74.80 | 44.88 |
| citric acid (mM) | 15.53 | 15.53 | 15.53 | 41.64 | 24.99 |
| dextrose (mM) | 141.82 | 283.64 | 177.05 | 135.96 | 81.58 |
| NaH₂PO₄ H₂O (mM) | 18.52 | 18.52 | 18.52 | | |
| adenine (mM) | | | 2.03 | | |
| 7,8-dimethyl 10-ribityl | 0.10 | 0.10 | 0.10 | 0.10 | 0.10 |
| isoalloxazine (μM) | | | | | |
| quencher (mM) | variable | variable | variable | variable | variable |

In Example 18, the red blood cell anticoagulant-based solution ABS 1 comprises a physiological saline solution, sodium citrate at a concentration of approximately about 89.59 mM, citric acid at a concentration of approximately about 15.53 mM, dextrose at a concentration of approximately about 141.82 mM, sodium phosphate monobasic at a concentration of approximately about 18.52 mM, 7,8-dimethyl-10-ribityl isoalloxazine at a concentration of about 10 μM, and an effective amount of a quencher.

The red blood cell anticoagulant-based solution ABS 2 comprises a physiological saline solution, sodium citrate at a concentration of approximately about 89.59 mM, citric acid at a concentration of approximately about 15.53 mM, dextrose at a concentration of approximately about 283.64 mM, sodium phosphate monobasic at a concentration of approximately about 18.52 mM, 7,8-dimethyl-10-ribityl isoalloxazine at a concentration of about 10 μM, and an effective amount of a quencher.

The red blood cell anticoagulant-based solution ABS 3 comprises a physiological saline solution, sodium citrate at a concentration of approximately about 89.59 mM, citric acid at a concentration of approximately about 15.53 mM, dextrose at a concentration of approximately about 177.05 mM, sodium phosphate monobasic at a concentration of approximately about 18.52 mM, adenine at a concentration of approximately about 2.03 mM, 7,8-dimethyl-10-ribityl isoalloxazine at a concentration of about 10 μM, and an effective amount of a quencher.

The red blood cell anticoagulant-based solution ABS 4 comprises a physiological saline solution, dextrose at a concentration of approximately about 135.96 mM, sodium citrate at a concentration of approximately about 74.80 mM, citric acid at a concentration of approximately about 41.64 mM, 7,8-dimethyl-10-ribityl isoalloxazine at a concentration of about 10 μM, and an effective amount of a quencher.

The red blood cell anticoagulant-based solution ABS 5 comprises a physiological saline solution, dextrose at a concentration of approximately about 81.58 mM, sodium citrate at a concentration of approximately about 44.88 mM, citric acid at a concentration of approximately about 24.99 mM, 7,8-dimethyl-10-ribityl isoalloxazine at a concentration of about 10 μM, and an effective amount of a quencher.

### Example 19

This example compares blood component additive solutions for addition to red blood cells separated from whole blood. Five commercially available red blood cell additive solutions were considered: AS-1, AS-3, AS-5, SAGM, and MAP. These solutions are listed as (1-5) in Table 8. To each known solution was added an effective amount of an endogenous photosensitizer, 7,8-dimethyl-10-ribityl isoalloxazine and an effective amount of a quencher. The photosensitizer may be present in the various solutions at any desired concentration from about 1 μM up to the solubility of the photosensitizer in the fluid, or dry medium, and preferably about 10 μM. For 7,8-dimethyl-10-ribityl isoalloxazine a concentration range between about 1 μM and about 160 μM is preferred, preferably about 10 μM. The composition of each additive solution is shown in Table 8 below, and varies in the amount of blood component additives present. The red blood cell additive solution components may be in a physiological solution, a dry medium adapted to be mixed with a solvent, including in tablet, pill or capsule form as described above.

In Example 19, the red blood cell additive solution 1 (Commercial Solution AS-1) comprises a physiological saline solution, dextrose at a concentration of approximately about 122.09 mM, adenine at a concentration of approximately about 2 mM, mannitol at a concentration of approximately about 41.16 mM, 7,8-dimethyl-10-ribityl isoalloxazine at a concentration of about 10 μM and a variable amount of at least one quencher.

TABLE 8

| | BLOOD ADDITIVE SOLUTIONS | | | | |
|---|---|---|---|---|---|
| BLOOD COMPONENT ADDITIVE | 1 (AS-1) | 2 (AS-3) | 3 (AS-5) | 4 (SAGM) | 5 (MAP) |
| dextrose (mM) | 122.09 | 61.04 | 49.94 | 49.94 | |
| adenine v (mM) | 2.00 | 2.22 | 2.22 | 1.25 | 0.10 |
| NaH₂PO₄H₂O (mM) | | 23.00 | | | 7.80 |
| mannitol (mM) | 41.16 | | 28.81 | 28.81 | 79.91 |
| sodium citrate (mM) | | 19.99 | | | 6.00 |
| glucose (mM) | | | | | 39.96 |
| citric acid (mM) | | 2.19 | | | |
| 7,8-dimethyl-10-ribityl isoalloxanzine (μM) | 10.0 | 10.0 | 10.0 | 10.0 | 10.0 |
| quencher (mM) | variable | variable | variable | variable | variable |

In Example 19, the red blood cell additive solution 2 (Commercial Solution AS-3) comprises a physiological saline solution, dextrose at a concentration of approximately about 61.04 mM, adenine at a concentration of approximately about 2.22 mM, sodium phosphate (monobasic) at a concentration of approximately about 23 mM, sodium citrate at a concentration of approximately 19.99, citric acid at a concentration of about 2.19 mM, 7,8-dimethyl-10-ribityl isoalloxazine at a concentration of about 10 μM and a variable concentration of at least one quencher.

The red blood cell additive solution 3 (Commercial Solution AS-5) comprises a physiological saline solution, dextrose at a concentration of approximately about 49.94 mM, adenine at a concentration of approximately about 2.22 mM, mannitol at a concentration of approximately about 28.81 mM, 7,8-dimethyl-10-ribityl isoalloxazine at a concentration of about 10 μM and a variable concentration of at least one quencher.

The red blood cell additive solution 4 (Commercial Solution SAGM) comprises a physiological saline solution, dextrose at a concentration of approximately about 49.94 mM, adenine at a concentration of approximately about 1.25 mM, mannitol at a concentration of approximately about 28.81 mM, 7,8-dimethyl-10-ribityl isoalloxazine at a concentration of about 10 μM and a variable concentration of at least one quencher.

The red blood cell additive solution 5 (Commercial Solution MAP) comprises a physiological saline solution, adenine at a concentration of approximately about 0.10 mM, sodium phosphate (monobasic) at a concentration of approximately about 7.80 mM, mannitol at a concentration of approximately about 79.91 mM, sodium citrate at a concentration of approximately about 6 mM, glucose at a concentration of approximately about 39.96 mM, 7,8-dimethyl-10-ribityl isoalloxazine at a concentration of about 10 μM and a variable concentration of at least one quencher.

The photosensitizer and quencher may also be added to the cells to be pathogen inactivated in a sterile saline or buffer solution without other additives.

### Example 20

In Example 20, each unit of red blood cells was separated from its plasma and diluted to a hematocrit of 30%. A solution containing 500 μM riboflavin, 0.9% saline and 4 mM quencher was added. The quencher added was glutathione. After gentle and thorough mixing, the units were illuminated for 50 minutes at 447 nm. The units were analyzed to determine the percent hemolysis of the red blood cells, and to detect alterations in the red cell membranes with DAT tests. Negative DAT results are evidence that no membrane alteration has occurred. Table 9 shows results of the DAT tests (as either + or −). Table 9 also compares the percentage of hemolysis of whole blood, red blood cells only after plasma expression and dilution with riboflavin and quencher (designated post-dilution), and after 50 minutes of illumination.

TABLE 9

| | | | DAT | DAT | DAT | DAT |
|---|---|---|---|---|---|---|
| Unit | Description | % Hemolysis | poly | Anti-IgG | Anti-C3d, C3b | Saline Control |
| 1 | Whole blood | 0.03 | − | − | − | − |
| 1 | Post-dilution | 0.09 | − | − | − | − |
| 1 | 50 min. | 0.19 | − | − | − | − |
| | illumination | | | | | |
| 2 | Whole blood | 0.06 | − | − | − | − |
| 2 | Post dilution | 0.21 | − | − | − | − |
| 2 | 50 min. | 0.22 | − | − | − | − |
| | illumination | | | | | |

### Example 21

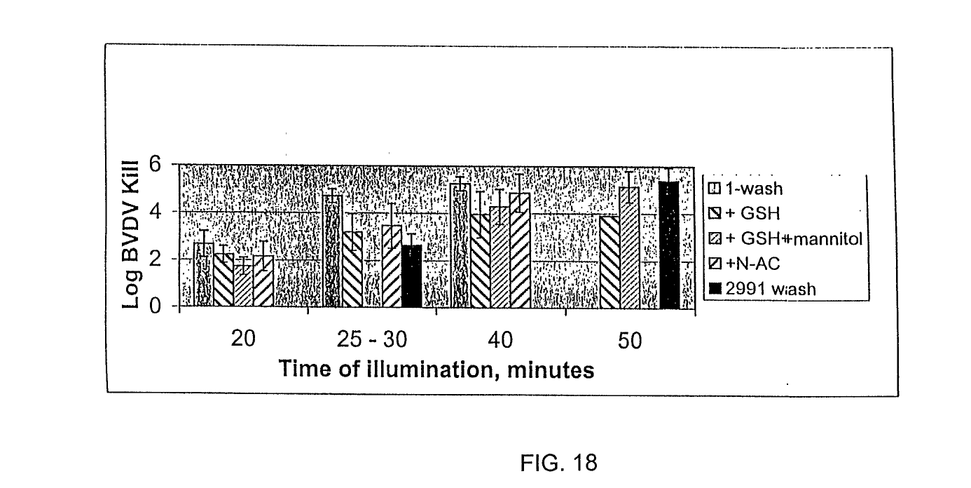

FIG. 18 is a graph of BVDV kill in red blood cells using different treatment conditions over time. In the figure, “GSH” stands for reduced glutathione and “N-AC” stands for N-acetyl cysteine. Red blood cells for the conditions “+GSH”, “+GSH +mannitol” and “+N-AC” were prepared by plasma expression, followed by dilution with 500 uM riboflavin and 4 mM quencher. Red cells for the condition labelled “1-wash” were prepared by plasma expression, resuspension in normal saline, recentrifugation and removal of wash solution, then dilution with 500 uM riboflavin and 4 mM GSH. Red cells for the condition labelled 2991 wash were washed with the 2991 wash the equivalent of 3 manual washes, then diluted in 500 μM riboflavin for illumination (no quencher was added). A 2991 wash refers to washing the red blood cells using a 2991 cell processing machine available from Gambro BCT, Inc. (Lakewood, Colo., USA.). The 2991 washes the red cells with 700 mL of 0.9% NaCl and 300 mL of 500 μM riboflavin in 0.9% NaCl. The product of the wash step is a suspension of concentrated RBCs at a 60 to 70% hematocrit with a riboflavin concentration of approximately 370 μM. A calculated volume of the washed red cells is mixed with 550 μM riboflavin in 0.9% NaCl in the ELP bag to obtain a suspension with a hematocrit of 50% and a volume of 276 mL. The 2991 wash removed extracellular proteins from the red cell suspension. When red cells are washed thoroughly prior to illumination, DAT results for red cells after illumination are negative. An additional benefit of the wash to the red cell process is increased rate of virus kill. The wash step also provides some virus removal.

Energies corresponding to the time points are: 20 minutes ˜45 J/cm2; 30 minutes ˜68 J/cm2; 40 minutes ˜90 J/cm2; 50 minutes ˜112 J/cm2. Error bars are one standard deviation on eiher side of the mean. All cells were diluted to 30% hematocrit. A final volume of 266 mL was present. 447 nm light was used for illumination. A 1-L ELP bag was used with 140 cpm mixing.

As can be seen in the FIG. 18, a 4 log BVDV viral kill may be obtained at 25-30 minutes of light exposure by expressing plasma from the collected red blood cells before the addition of the irradiation solution containing 4 mM glutathione and 500 M riboflavin.

### Example 22

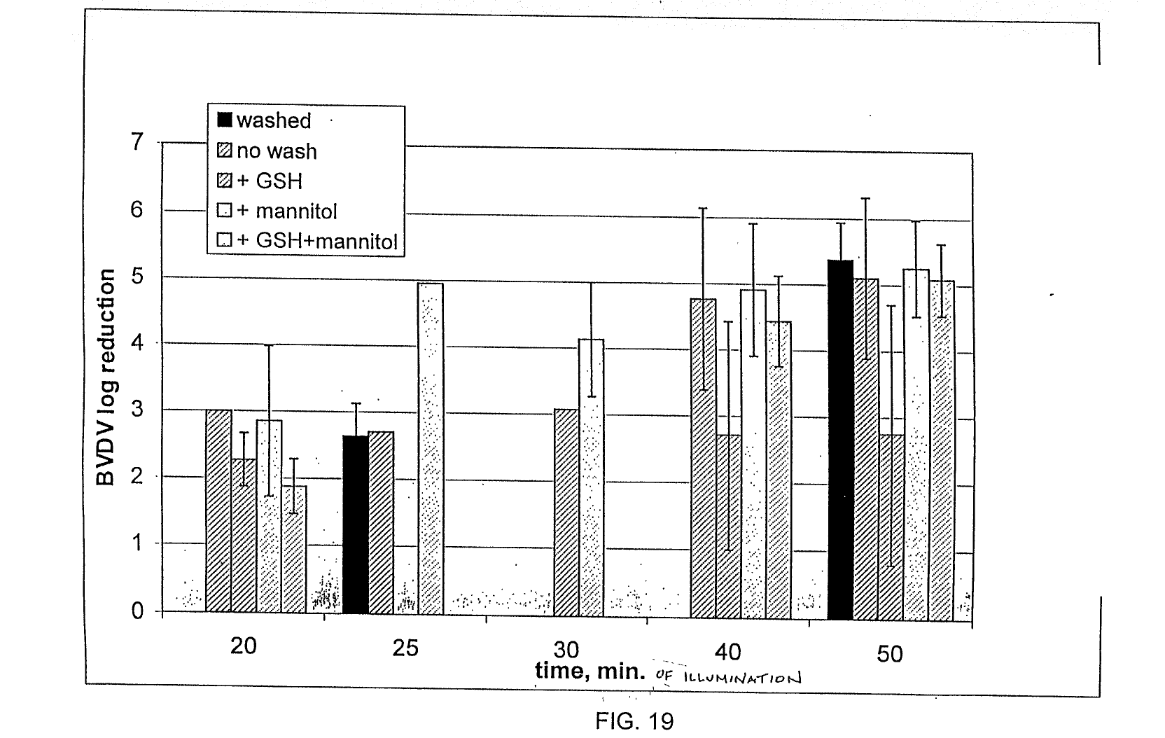

FIG. 19 is a graph comparing the log reduction of BVDV in washed red blood cells as compared to non-washed red blood cells. As can be seen from the figure, there is a greater variability in results obtained from the unwashed red blood cells due to the presence of plasma proteins in the unwashed red blood cells. The abbreviations and other conditions used in FIG. 19 are the same as in FIG. 18. Mannitol was also added.

### Example 23

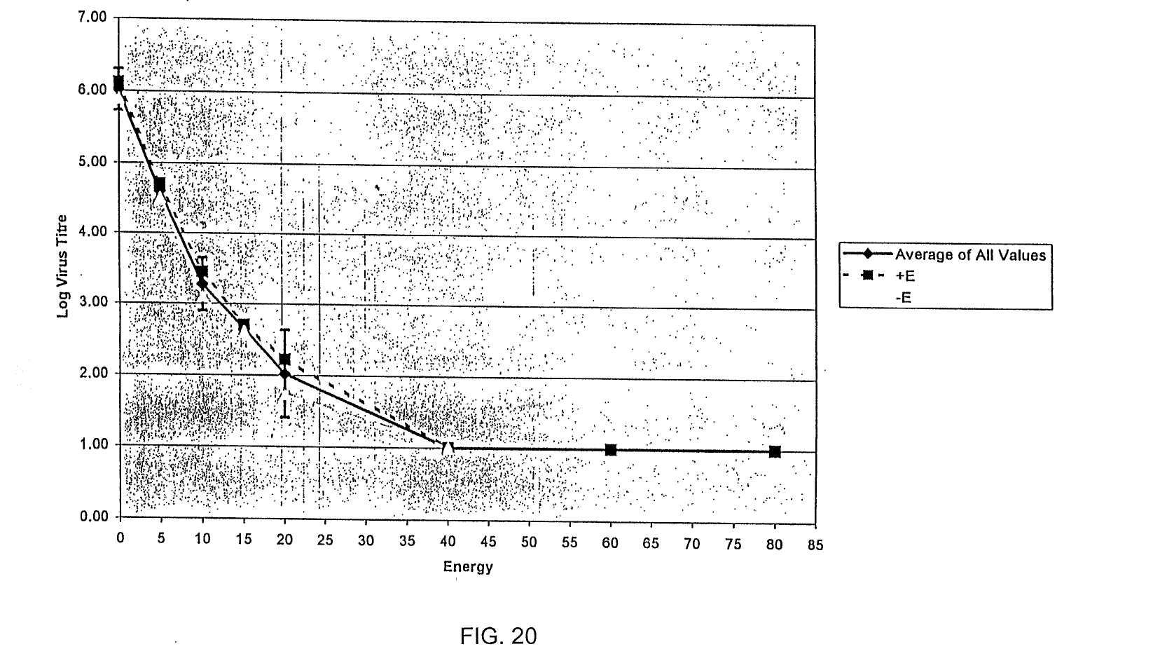

FIG. 20 is a graph indicating the inactivation kinetics of BVDV virus in the presence and absence of Vitamin E in platelets. FIG. 20 shows log virus titre. 419 nm light was used with 30 uM riboflavin, with 120 cpm linear mixing.

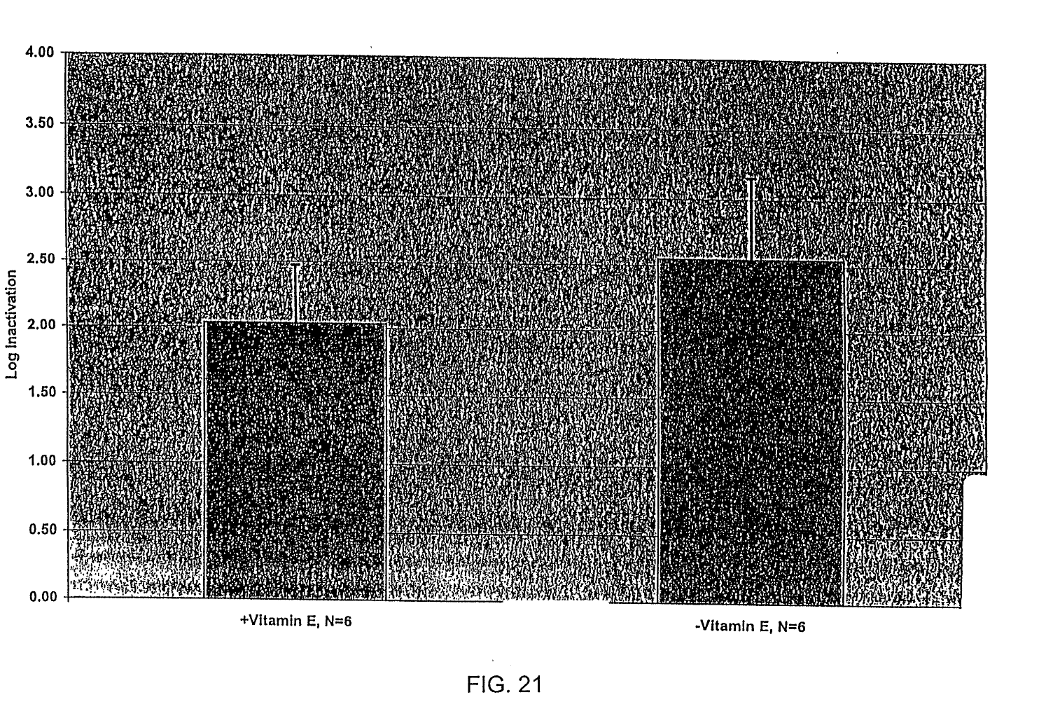

FIG. 21 is a graph indicating the level of inactivation observed between platelet samples with and without Vitamin E. The end results shown in FIGS. 20-21, under comparable conditions, indicate that there is not a substantial reduction in virus kill levels in the presence of Vitamin E.

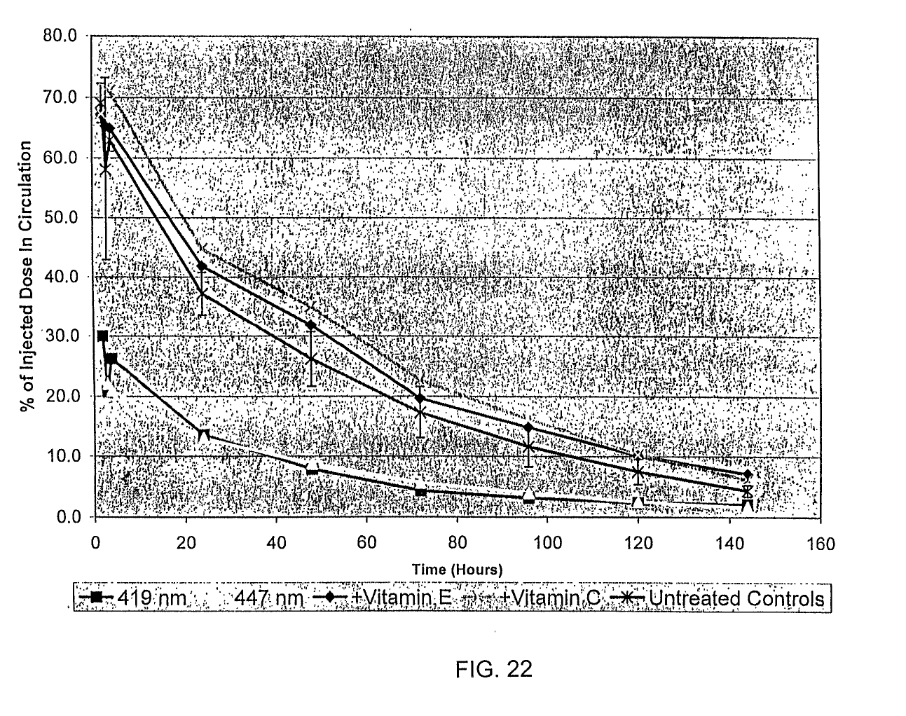

FIG. 22 is a graph showing the results of survival of radiolabelled primate platelets under varying treatment conditions (with and without antioxidants and untreated controls). The results indicate that there is a substantial improvement (back to untreated control levels) in the recovery of cells observed with the addition of vitamin E and vitamin C.

### Example 24

TABLE 10

| | | | % | DAT Results | | |
|---|---|---|---|---|---|---|
| | | Quencher | Hemol- | | | Anti-C3d, |
| Unit | Condition | (mM) | ysis | Poly | Anti-IgG | C3b |
| 1 | 190 J/cm² | 4 mM NAC | 1.01 | − | − | − |
| 2 | 190 J/cm² | 6 mM NAC | 0.52 | − | − | − |
| 3 | 190 J/cm² | 8 mM NAC | 0.40 | − | − | − |
| 4 | 190 J/cm² | 12 mM NAC | 0.49 | − | − | − |
| 5 | 190 J/cm² | 4 nM GSH | 0.47 | − | − | − |
| 6 | 190 J/cm² | none | 0.25 | + | + | + |

Table 10 shows DAT results of red blood cells incubated with a quencher and riboflavin and illuminated at 190 J/cm². The cells were not washed prior to the addition of quencher and riboflavin. The cells were illuminated in a 150 mL ELP bag in a volume of 77 mLs solution and 38 mLs of air. The red blood cells were diluted to a hematocrit of 30%. The quenchers, either N-acetyl-L-cysteine (NAC) or glutathione (GSH) were added to each unit in varying concentrations in 500 uM riboflavin and 0.9% saline. The control unit containing no quencher contained 500uM riboflavin in 0.9% saline.

As can be seen from the table, the units containing higher concentrations of quenchers underwent a lower percentage of hemolysis than units which had lower concentrations of quenchers or no quenchers at all. The addition of quenchers to the illumination solution prevented positive DAT results.

With all the solutions set forth above it is understood that all concentrations are approximate and may be varied as will be readily understood by one skilled in the art. Also, from the concentrations given above the gram weights can be readily determined if the photosensitizer or additive constituents are to be added in dry form.

It will be readily understood by those skilled in the art that the foregoing description has been for purposes of illustration only and that a number of changes may be made without departing from the scope of the invention. For example, other photosensitizers than those mentioned may be used, preferably photosensitizers which bind to nucleic acid and thereby keep it from replicating, and more preferably those which are not toxic and do not have toxic breakdown products. In addition, equivalent structures to those described herein for constructing a flow-through system for decontamination of fluids using photosensitizers may be readily devised without undue experimentation by those skilled in the art following the teachings hereof. In addition quenchers other than those specifically exemplified may be used.

What is claimed is:

1. An additive solution for irradiating a blood component which may contain pathogens comprising: an endogenous photosensitizer and a quencher.

2. The additive solution of claim 1, wherein the quencher is present in an amount less than 12 mM.

3. The additive solution of claim 1, wherein the quencher is present in an amount greater than 4 mM.

4. The additive solution of claim 1, wherein the endogenous photosensitizer is selected from the group consisting of: endogenous alloxazines.

5. The additive solution of claim 4, wherein the endogenous photosensitizer is 7,8-dimethyl-10-ribityl isoalloxazine.

6. The additive solution of claim 4, wherein the blood component is red blood cells.

7. The additive solution of claim 4, wherein the blood component is platelets.

8. The additive solution of claim 4, wherein the quencher is glutathione.

9. The additive solution of claim 4 wherein the quencher is an antioxidant.

10. The additive solution of claim 9 wherein the antioxidant is chosen from the group consisting of vitamin E, trolox and TPGS.

11. The additive solution of claim 9 wherein the antioxidant contains a thiol group.

12. The additive solution of claim 11 wherein the antioxidant is chosen from the group consisting of n-acetyl-cysteine, cysteine and glutathione.

13. The additive solution of claim 4 wherein the quencher is an amino acid.

14. The additive solution of claim 13 wherein the amino acid is chosen from the group consisting of tryptophan, tyrosine, histidine, adenine and methionine.

15. The additive solution of claim 4, wherein the quencher is N-acetyl cysteine.

16. The additive solution of claim 15, wherein the N-acetyl cysteine is present in an amount of about 8 mM.

17. The additive solution of claim 15, wherein the N-acetyl cysteine is present in an amount of about 12 mM.

18. The additive solution of claim 1, wherein the endogenous photosensitizer is 7,8,-dimethyl-10-ribityl isoalloxazine and is added in an amount of around 500 μM.

19. The additive solution of claim 8 wherein the glutathione is added in an amount of around 4 mM glutathione.

20. The additive solution of claim 4 further comprising 0.9% sodium chloride.

21. An additive solution for irradiating a blood component which may contain pathogens comprising: an endogenous photosensitizer, a quencher and a solution useful for storing blood components.

22. A storage solution for storing one or more blood components that have been irradiated comprising:
a solution useful for storing blood components and a quencher.

23. The storage solution of claim 22, wherein said quencher is glutathione.

24. The storage solution of claim 22, wherein said quencher is N-acetyl cysteine.

25. The storage solution of claim 22, wherein said solution useful for storing blood components is AS3 and said quencher is glutathione.

26. The storage solution of claim 22, wherein said quencher is selected from the group consisting of vitamin E, TPGS and trolox.

27. A dry composition adapted to be mixed with a solvent, comprising a quencher and an endogenous alloxazine photosensitizer.

28. The dry composition of claim 27, further comprising a member of the group selected from: tri-sodium citrate, sodium acetate, potassium chloride, magnesium chloride, sodium gluconate and sodium phosphate.

29. A blood bag adapted to receive blood or blood components wherein the bag contains the dry medium of claim 27.

30. The dry composition of claim 28, wherein the dry composition is in a tablet, pill or capsule form.

31. A method of inactivating pathogens in a blood component which may contain pathogens comprising:
adding an additive solution containing a photosensitizer and a first quencher to the blood component;
illuminating the blood component and additive solution for a time sufficient to inactivate any pathogens contained therein.

32. The method of claim 31, wherein the blood component is red blood cells and the quencher is vitamin E.

33. The method of claim 31, further comprising storing the blood component in a solution useful for storing blood components which may contain a second quencher.

34. A method of inactivating pathogens in red blood cells which may contain pathogens comprising:
expressing plasma from a unit of whole blood to create a plasma reduced red blood cell containing product;
adding an additive solution containing riboflavin and a first quencher to the plasma reduced red blood cell containing product;
illuminating the plasma reduced red blood cell containing product and additive solution for a time sufficient to inactivate any pathogens contained therein; and
storing the irradiated red blood cells in a solution useful for storing blood components which may contain a second quencher.

35. A method for quenching side reactions of a pathogen inactivating compound in a biological fluid containing blood or blood products as well as pathogens comprising the steps of:
treating the biological fluid with a pathogen inactivating compound wherein the pathogen inactivating compound comprises riboflavin;
adding to the biological fluid and riboflavin a quencher in an amount sufficient to reduce the level of side reactions without interfering with the inactivation of pathogens by riboflavin; and
exposing the biological fluid and riboflavin and quencher to light of a sufficient wavelength to inactivate any pathogens contained in the biological fluid.

36. The method of claim 35 wherein the quencher is an antioxidant.

37. The method of claim 36 wherein the antioxidant is chosen from the group consisting of vitamin E, trolox and TPGS.

38. The method of claim 36 wherein the antioxidant contains a thiol group.

39. The method of claim 38 wherein the antioxidant is chosen from the group consisting of n-acetyl-cysteine, cysteine and glutathione.

40. The method of claim 35 wherein the quencher is an amino acid.

41. The method of claim 40 wherein the amino acid is chosen from the group consisting of tryptophan, tyrosine, histidine, adenine and methionine.

42. The method of claim 35 wherein the quencher is vitamin C.

43. The additive solution of claim 1 wherein the quencher is N-acetyl cysteine or an amino acid.

44. The method of claim 35, wherein the riboflavin is added in an amount of around 500 μM.

45. The method of claim 35, wherein the quencher is present in an amount greater than 4 mM.

46. The method of claim 35, wherein the quencher is present in an amount less than 20 mM.
